(19) United States
(12) Patent Application Publication
(10) Pub. No.: US 2025/0305873 A1
(43) Pub. Date: Oct. 2, 2025

(54) SYSTEM AND METHOD FOR SAMPLING TERAHERTZ PULSES USING MODULATED DIFFERENCE-FREQUENCY IN REPETITION RATES OF FEMTOSECOND LASERS

(71) Applicant: THE RESEARCH FOUNDATION FOR THE STATE UNIVERSITY OF NEW YORK, Albany, NY (US)

(72) Inventors: Mohammad Hassan ARBAB, South Setauket, NY (US); Zachery HARRIS, Stony Brook, NY (US)

(73) Assignee: THE RESEARCH FOUNDATION FOR THE STATE UNIVERSITY OF NEW YORK, Albany, NY (US)

(21) Appl. No.: 18/866,778

(22) PCT Filed: May 17, 2023
(86) PCT No.: PCT/US2023/022526

§ 371 Date: Nov. 18, 2024

Related U.S. Application Data
(60) Provisional application No. 63/343,309, filed on May 18, 2022.

(51) Int. Cl. G01J 3/06; G01J 3/28; G01N 21/3581

(52) U.S. Cl. CPC G01J 3/06; G01N 21/3581; G01J 2003/062; G01J 2003/2879

(57) ABSTRACT

A system and method for sampling terahertz pulses using modulated difference-frequency in repetition rates of femtosecond lasers. The system includes at least two femtosecond lasers used with photoconductive antennas to generate and detect, respectively, terahertz (THz) frequency pulses. The difference in frequency between the repetition-rates of the two lasers, i.e., the “difference-frequency” causes sampling of sequential THz pulses to occur at different relative locations in the time-domain which is used to reconstruct the waveform. When the difference-frequency is varied, the waveform is sampled at different intervals over the full repetition period of the THz pulse. An ECOPS technique includes modulating this difference frequency e.g., in a sinusoidal pattern, so that the sampling is confined to a small range of the period of the THz pulses to improve acquisition speed. The system and method corrects the locations of the time-domain samples and their non-linear behavior in the reconstructed ECOPS waveform.

### CROSS-REFERENCE TO RELATED APPLICATION

This application claims the benefit of and priority to U.S. Provisional Application Ser. No. 63/343,309 filed on May 18, 2022, the entirety of which is incorporated by reference.

### STATEMENT REGARDING FEDERALLY SPONSORED RESEARCH OR DEVELOPMENT

This invention was made with government support under GM112693 awarded by the National Institutes of Health. The government has certain rights in the invention.

### FIELD OF THE DISCLOSURE

This disclosure relates to Terahertz (THz) time-domain spectroscopy systems and methods, and particularly a novel time domain sampling system and method employing terahertz laser scanning devices.

### BACKGROUND

Terahertz (THz) time-domain spectroscopy may be used for various applications. These applications may include non-destructive analysis, biomedical imaging for diagnosis of burn wounds and cancer margin delineation, art preservation and security, among other applications.

Accordingly, a wide variety of imaging modalities have been developed to serve these purposes. However, portable THz systems are still in their early stages of development. Existing THz cameras do not provide spectroscopic information, so many investigations use single-pixel techniques such as moving the target in front of a stationary THz time-domain spectroscopy (THz-TDS) setup to form spectral images. This strategy is only feasible for small, easily moved samples which can be brought to the system and is limited by problems of alignment and phase ambiguity in reflective imaging.

Single-pixel imaging techniques based on compressed sensing, which do not require such motion-controlled stages, have been employed but these methods require the entire sample area to fit within the collimated beam.

Other portable systems request motion stages in order to move a scanning head over a sample or only acquire a single row of pixels. However, systems in which a single-detector scanning head is moved over a stationary target suffer similar alignment problems to moving-target systems.

While portable THz spectroscopy has been demonstrated for single-point measurement using the battery-powered Micro-Z and Mini-Z devices, additionally, one-dimensional line scanning has been demonstrated using beam-steering along a single axis. However, in order to form an image, these devices would still need to be mechanically translated across the surface of a target.

To address the need for portable full spectroscopic THz imaging devices, there has been developed the THz PHASR (Portable HAndheld Spectral Reflection) Scanner such as described in commonly-owned, co-pending U.S. patent application Ser. No. 17/438,630. This instrument acquired THz-TDS images over a 12×19 mm² field of view (FOV) using an f-θ lens and a mirror mounted in telecentric alignment on a motorized gimbal. An ASynchronous Optical Sampling (ASOPS) system was used to provide acquisition rates of 100 waveforms/s.

### SUMMARY

In one spect, there is disclosed an improved terahertz (THz) spectrometer and method of operation.

The improved terahertz spectrometer, when embodied as a handheld THz-TDS scanner system, is particularly characterized as having: 1) improved field of view (FOV); and 2) increased speed of the TDS trace acquisitions.

According to this aspect, the improved field of view (FOV) is attributable, in part, to removing the distortions or non-linearities inherent to its scanning geometry and the mechanical limits of the gimbal, and the increased scanning speed is attributable, in part, to increasing the acquisition rate of the ASOPS technique using an Electronically Controlled Optical Sampling (ECOPS) technique.

According to one aspect, there is provided a method of operating a terahertz (THz) spectrometer. The method comprises: emitting light by a first laser pulse generator; configuring, by a motor controller, a 2-Dimensional (2D) gimbaled mirror, the 2D gimbaled mirror comprising a single mirror mounted in a frame and configurable for rotation about a first axis of rotation and a second axis of rotation under a control of the motor controller, the 2D gimbaled mirror adapted to focus the emitted light on a target through a lens; scanning, using the motor controller, the emitted light on the target in two dimensions; detecting, by a detector, light signals reflected from the target over a sampling time period, using a second laser pulse generator to sample the detected light signals at different time-domain sampling locations within the sampling time period, the sampling of the detected light signals within the time period comprising obtaining multiple trace waveforms comprising sampling locations in both forward signal components and backwards signal components over the time period; and applying a transformation model to adjust the sampling locations of the obtained multiple trace waveforms of the detected light signals over the sampling time period to correct for a non-linearity present between expected locations of features within the detected light signals reflected from the sample and corresponding locations of the features in both the sampled both forward signal components and backwards signal components.

According to another aspect, there is provided a method of calibrating a terahertz (THz) spectrometer. The method comprises: obtaining, using a processor in the spectrometer, a first set of one or more time domain signals representative of a target sample being scanned over a time period; obtaining, using the processor in the spectrometer, a second set of time domain signals representative of a target sample being scanned using an electronically controlled optical scanning (ECOPs) THz measurement applied to the target sample, the second set of time domain signals comprising both forward signal components and backwards signal components over the time period; determining, using the processor, locations of one or more features in the first set of signals within the time period; determining corresponding one or more features in the second set of signals within the time period, the corresponding one or more features of the second set of time domain signals having different locations within the time period; generating, using the processor, a model used to temporally transform the second set of signals into a set of signals so that the corresponding one or more features within the time period align with the locations of one or more features in the first set of signals within the time period; and using the model to correct for a timing error in subsequent performed ECOPS optical scanning measurements applied to the target sample.

In yet another aspect, there is provided a terahertz (THz) spectrometer. The spectrometer comprises: a first laser pulse generator for emitting light; a motor controller for controlling a 2-Dimensional (2D) gimbaled mirror, the 2D gimbaled mirror comprising a single mirror mounted in a frame and configurable for rotation about a first axis of rotation and a second axis of rotation under a control of the motor controller, the 2D gimbaled mirror adapted to focus the emitted light on a target through a lens; a signal detector for detecting light signals reflected from the target over a sampling time period; a second laser pulse generator to sample the detected light signals at different time-domain sampling locations within the sampling time period, the sampling of the detected light signals within the time period comprising obtaining multiple trace waveforms comprising sampling locations in both forward signal components and backwards signal components over the time period; and a hardware processor programmed with instructions for configuring the hardware processor to apply a transformation model for adjusting the sampling locations of the obtained multiple trace waveforms of the detected light signals over the sampling time period to correct for a non-linearity present between expected locations of features within the detected light signals reflected from the sample and corresponding locations of the features in both the sampled both forward signal components and backwards signal components.

In a further aspect, there is provided a computer program product for performing operations. The computer program product includes a storage medium readable by a processing circuit and storing instructions run by the processing circuit for running a method. The method is the same as listed above.

### BRIEF DESCRIPTION OF THE DRAWINGS

Further features as well as the structure and operation of various embodiments are described in detail below with reference to the accompanying drawings. In the drawings, like reference numbers indicate identical or functionally similar elements.

FIG. 1A illustrates an imaging system having a terahertz spectrometer including optical components and depicting a representative target in accordance with aspects of the disclosure;

FIG. 1B depicts a handheld THz_TDS PHASR 2.0 scanner device according to one aspect of the present invention;

FIG. 2A depicts a simplified model of the beam steering geometry in PHASR Scanner 2.0 in one aspect of the present disclosure;

FIG. 2B depicts a simplified representation of the gimballed mirror in PHASR 2.0 showing the azimuthal axis, aligned with the incident beam, and elevation axis perpendicular to it;

FIG. 3 shows a resultant scanning pattern of the THz_TDS scanner providing a larger and significantly more rectilinear FOV in accordance with aspects of the disclosure as compared to the FOV of a prior scanner design;

FIGS. 4A-4B provide a conceptual depiction of the difference between the ASOPS with fixed Δf and the ECOPS techniques using square wave modulation and sinusoidal wave modulation of Δf;

FIG. 5 depicts a state model drift compensation method according to one embodiment of the invention;

FIG. 6A particularly illustrates a portion of the PHASR 2.0 Scanner system providing a probe laser beam scan signal shown impinging on an exemplary target multi-layer reference sample for use in providing constant sampling points in the time-domain;

FIG. 6B depicts an exemplary plot of the detected signal amplitude (a.u.) along the Y-axis against time τ (in ps) along the X-axis for the scanned example reference sample in FIG. 6A;

FIG. 6C depicts, for the example system depicted in FIGS. 6A, a plot of the distributions of the measured delay between the two pulses (peaks) particularly as a count along the Y-axis against time delay between the pulses labeled as Δτₚₖₛ (ps) along the X-axis in an example implementation;

FIG. 6D illustrates a comparison of the different between the measured ASOPS and ECOPS locations of the time-domain reflection peaks in the forwards and backwards directions for all ECOPS datasets; in the illustrative example, accordance with aspects of the disclosure;

FIG. 6E shows acquisition of “M” multiple pairs of ECOPS (forwards and backwards) signals with each paired ECOPs signal being shifted forward or backward in time in an aspect of the disclosure;

FIGS. 7A and 7B depict plots of the full extent of the timing error by comparing the expected time axis function calculated from Eq. (7), to the actual corresponding ECOPS time-domain peaks in both forward and backwards directions (FIG. 7A), with FIG. 7B showing resulting time-domain trend in error values for the illustrative scanner example of FIG. 6A;

FIG. 8 shows the MSE of the peak locations in the corrected time-axis results as a function of the fitting polynomial order for the illustrative scanner example of FIG. 6A;

FIGS. 9A-9E shows the comparison between the model calculated from Eq. (7) (dashed line) and polynomial fit (further dashed line) to the actual peak locations; the difference from the calculated model (FIG. 9B) and difference from the polynomial fit (FIG. 9C) highlighting the improved correspondence to ASOPS peak locations; and the corrected time domain signal (FIG. 9D) and measurement of Δτₚₖₛ demonstrating that after nonlinear time-axis correction the ECOPS traces much more closely match each other and the ASOPS reference;\

FIG. 10 shows a table depicting single-shot acquisition time and the maximum THz-TDS sampling range for each of the setting values in an exemplary embodiment;

FIG. 11A depicts a normalized representative time domain signals reflected from a flat mirror obtained using ASOPS and ECOPS methods;

FIG. 11B depicts a standard deviation of time of arrival (ToA) for all sets of ASOPS and ECOPS acquisitions as a function of measurement time;

FIG. 11C depicts a Fourier transform of the time domain signals in FIG. 11A as well as noise measurements in ASOPS, and ECOPS, acquired with the same parameters;

FIG. 11D depicts an exemplary the maximum dynamic range and FIG. 11E depicts an exemplary maximum usable bandwidth of each set of acquisitions as a function of measurement time;

FIG. 11F provides a key or legend to provide the values for the plots depicted in FIGS. 11A-11E.

FIG. 12A-12B are plots depicting a distribution of measured lactose resonance with FIG. 12A depicting results of ASOPS measurements and FIG. 12B depicting results of ECOPS measurements including values calculated from forward and backwards directions using Eq. (7) as well as time-axis corrected values;

FIG. 12C is a frequency domain plot of select ASOPS shown as box in FIG. 12A and ECOPS, for ECOPS forward direction and backwards direction before time-axis correction, respectively, and shown as the plot after time-axis correction.

FIG. 12D depicts a standard deviation of measured resonance location for each set of acquisitions;

FIGS. 13A-13D depicts demonstration images using ECOPS measurement technique in an example implementation;

FIG. 14 depicts one embodiment of a calibration method for calibrating the PHASR 2.0 THz handheld scanner using ASOPs optical scanning hardware making ECOPs measurements for imaging at an increased field of view and at increased sampling acquisition rates; and

FIG. 15 illustrates a schematic of an example computer or hardware processing system that can implement computing operations for determining the ECOPS polynomial correction function for correcting for the non-linearities present between sample signal sets along the time axis as the ECOPs scanner acquisition speed increases.

### DETAILED DESCRIPTION

The following detailed description of embodiments of the invention will be made in reference to the accompanying drawings. In describing the invention, explanation about related functions or constructions known in the art are omitted for the sake of clearness in understanding the concept of the invention to avoid obscuring the invention with unnecessary detail.

Embodiments of the invention described herein provide scanning devices and scanning systems which can acquire three-dimensional spectroscopic images in a terahertz range.

More particularly, the present disclosure relates to a portable full spectroscopic THz imaging device that improves the portable THz imaging scanner device described in applicant's commonly-owned, co-pending U.S. patent application Ser. No. 17/438,630, by providing having an increased FOV and a redesigned beam steering geometry based on a heliostat configuration, which eliminates any distortions due to the intercoupling of the scanning axes in the gimballed motors of the prior THz imaging scanner device described in applicant's commonly-owned, co-pending U.S. patent application Ser. No. 17/438,630 (hereinafter “Scanner 1.0”) the whole contents and disclosure of which is incorporated by reference as if fully set forth herein

Whereas the prior Scanner 1.0 THz imaging device relied upon ASOP optical sampling acquisition techniques to provide fast acquisition rates, in one aspect, the portable full spectroscopic THz imaging device of the present disclosure provides an improved system and method for sampling terahertz pulses including implementing an ECOPS optical sampling technique that modulates the difference-frequency in repetition rates of femtosecond lasers. The system and method includes at least two femtosecond lasers used with photoconductive antennas to generate and detect, respectively, terahertz (THz) frequency pulses. The difference in frequency between the repetition-rates of the two lasers, i.e., the “difference-frequency” causes sampling of sequential THz pulses to occur at different relative locations in the time-domain which is used to reconstruct the waveform. When the difference-frequency is held constant, as in the embodiment of the Scanner 1.0 portable THz imaging device, the waveform is sampled at regular intervals over the full repetition period of the THz pulse. The ECOPS technique implemented in the portable full spectroscopic THz imaging device of the present disclosure includes modulating this difference frequency e.g., in a sinusoidal pattern, so that the sampling is confined to a small range of the period of the THz pulses to improve acquisition speed.

That is, to increase the speed of the TDS trace acquisitions, an existing ASOPS electronic hardware is adopted to perform Electronically Controlled OPtical Sampling (ECOPS) instead which change produces a new scanner with a large, 43×27 mm² FOV at a scan time on the order of 5 msec (ms) and capable of recording 2000 waveforms per second, representing a 20-fold increase in acquisition speed.

However, as the system response to modulation efforts alters the actual shape of the modulation and as such, the locations of the time-domain sampling, the system and method described herein corrects the locations of the time-domain samples and their non-linear behavior in the reconstructed ECOPS waveform.

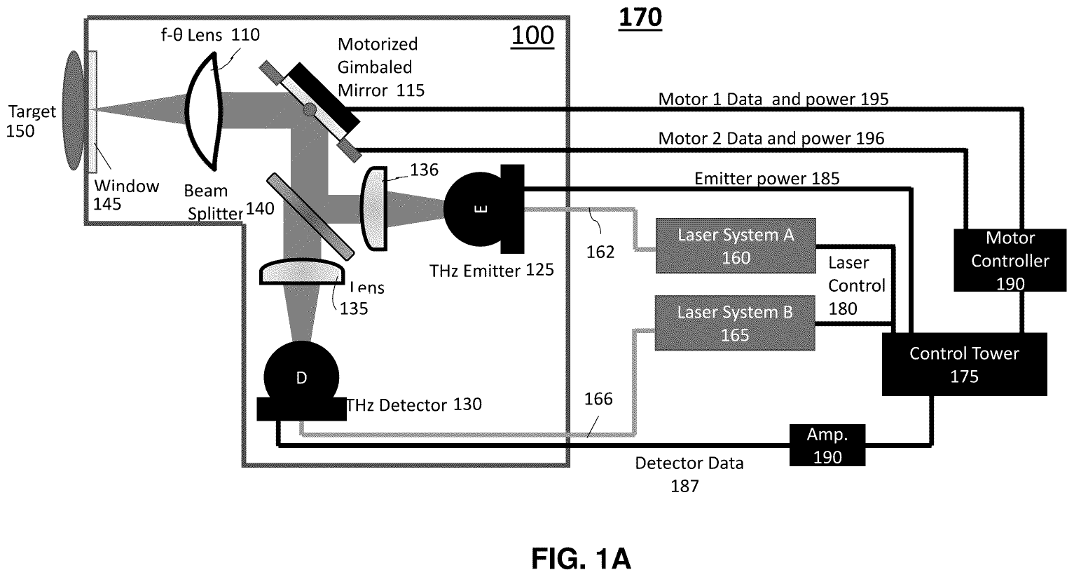

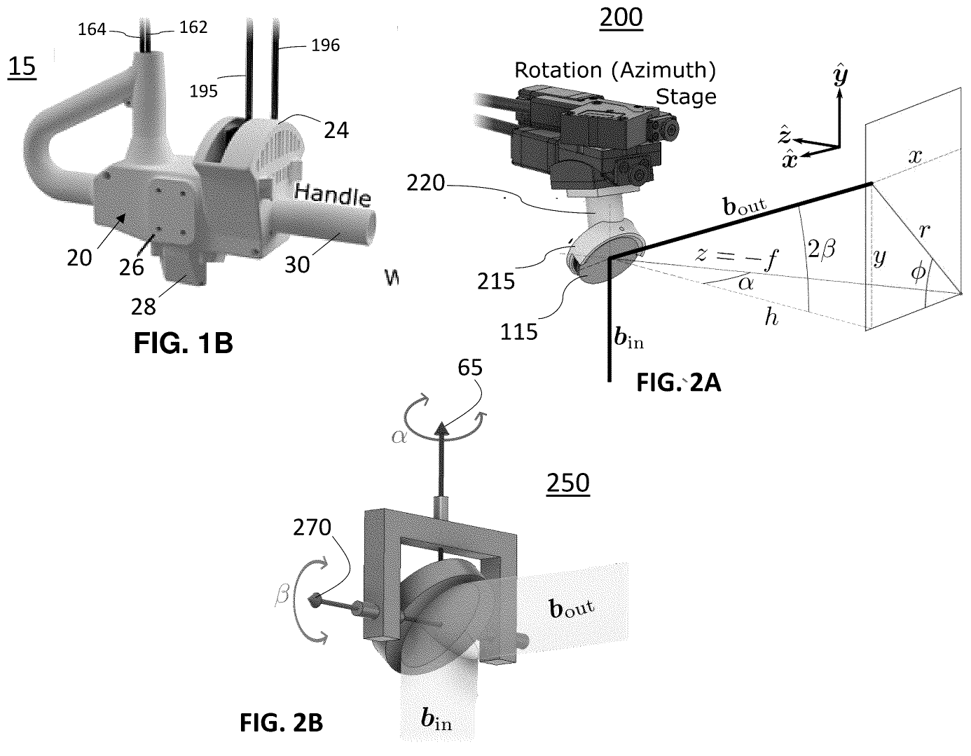

FIG. 1A shows a schematic of a general telecentric THz-TDS imager 100 (also referred to herein as handheld scanning device “Scanner 2.0”) for scanning a target 150 in accordance with aspects of the disclosure. In some aspects of the disclosure, the handheld scanning device may comprise a focusing lens 110 (also references herein as the scanning lens), a motorized gimbaled mirror 115, a silicon beam splitter 140, a terahertz emitter 125, a terahertz detector 130 and collimating lens 135 positioned adjacent the detector. More specifically, the telecentric imaging system shown in FIG. 1A includes photoconductive antenna (PCA) emitter and detector 125, 130, respectively, each respective emitter 125, detector 130 paired with a respective collimating/focusing lens 135, 136. The beam splitter, BS 140, directs the generated laser beam 128 to the collocated section containing the gimbaled beam-steering mirror, GM 115, and the f-θ imaging lens 110. An optional imaging window, W 145, is shown at the target plane.

As depicted, the focusing lens 110 is an f-theta lens (also referred to as f-θ lens). An f-theta lens is telecentric. The f-theta lens has advantages over other types of lens. For example, the focal plane of an ideal f-theta lens is planar rather than a curved surface. This allows for achieving a target plane, which is particularly suited to scan a flat surface of a target 50. Further, in a telecentric lens, the focused beam is perpendicular to the target plane over its full range, thus the reflected signal (from the target) returns by the same path as the incident beam, removing a need for a second set of optics for descanning. Additionally, the time of flight for all scanning angles (of the motorized gimbaled mirror 115) is substantially the same which allows for more accurate measurement of a depth of features in the target. Additionally, the lens may have the property that the focused beam has a substantially constant spot-size.

While the focusing lens 110 depicted in FIG. 1A is an f-θ lens, other lenses or a combination of lenses may be used depending on the application and requirements. For example, a biconvex lens or a plano convex lens may be used.

In an aspect of the disclosure, the focusing lens 110 is rotationally symmetric and has a depth of focus of at least 2 mm.

In an aspect of the disclosure, the f-theta lens may be formed of high-density polyethylene (“HDPE”). However, the material used for the f-theta lens is not limited to HDPE and other materials may be used. For example, in some aspects of the disclosure, the f-theta lens may be made from poly 4 methyl pentene-1 (“TPX”) or Polytetrafluoroethylene (“PTFE”).

In some aspects, the f-theta lens 110 may be designed to have a spectral performance between 0.3 and 1 THz with a center frequency of 0.5 THz. In other aspects, the range may be larger. For example, the f-theta lens may be designed to have a spectral performance, i.e., bandwidth, between 0.05 and 1.6 THz. In other aspects, the f-theta lens may be designed to have a spectral performance between 0.05 and 3 THz. The shape of the lens may be customized to achieve a target frequency range. In other aspects, the material for the lens may be selected to achieve the target range. The shape of the lens may be different depending on the material used. For example, a PTFE lens may be thicker than an HDPE lens for a target frequency range.

As shown in the schematic of FIG. 1A, the terahertz light is generated by a commercial fiber-coupled photoconductive antenna (PCA) 125, collimated, and then directed through a beam splitter 140. The beam splitter 140 is positioned to direct a portion of the light emitted by the emitter toward the single mirror 115 and a portion of the reflected light by the target toward a PCA detector 130. In an embodiment, both photoconductive antennas 125, 130 are positioned relatively orthogonal to each other and configured to be excited at a wavelength ranging anywhere from 1300, 1550 and 1600 nm. The beam is steered across the custom high-density polyethylene (HDPE) f-θ lens 110 by the gimballed mirror 115 located at the lens' rear focal point, thus creating a telecentric configuration. In this design, the lens 110 maintains a normal incidence angle on the target, a flat focal surface plane, a constant focal spot size, and constant optical path length for all positions within the FOV. The normal incidence and flat focal plane mean that the reflected beam is collocated with the incident beam, returning by the same path to the beam splitter where it is directed towards the detector PCA 130 which is also coupled to a fiber optic cable. In an embodiment, a time of arrival of the reflected light at the detector is substantially independent of angles of rotation to direct emitted light to a specific position on the target. Additionally, a spot size of the light at a focal length of the lens is substantially independent of angles of rotation Optionally, an imaging window 145 can be used at the focal plane to flatten soft targets and allow for self-calibration reference measurements using the air-window interface reflections.

As further shown, FIG. 1A the a handheld terahertz scanner 100 is a component of an imaging system 170 in accordance with aspects of the disclosure.

The system 170 shown in FIG. 1A is only by way of example of an imaging system having a handheld terahertz scanner 100 described herein. A handheld terahertz scanner as described herein may be used in other types of imaging systems and the imaging system is not limited to the system depicted in FIG. 1A. The example imaging system 170 comprises a handheld terahertz scanner 100 as described above. The example imaging system 170 shown in FIG. 1A is an example set up when PCAs are used for the THz emitter 125 and THz detector 130. The set up shown in FIG. 1A is for the asynchronous optical sampling system (ASOPS) or ECOPS. A similar set up may be used for electronically controlled optical sampling (ECOPS) for increased acquisition speed. As depicted, a laser system 160, 165 is respectively coupled to the THz emitter 125 and THz detector 130. For example, laser system A 160 is coupled to the THz emitter 125 via a fiber optic cable 162 and laser system B 165 is coupled to the THz detector 130 via a fiber optic cable 166. Each laser system 160, 165 comprises a femtosecond laser source. The laser may emit a wavelength of 1550 nm or 1560 nm. However, other wavelengths may be used such as 1300 and 1600 nm. The lasers are controlled via control electronics in a control tower 175. The control tower 175 is connected to the laser systems 160, 165 via one or more cables 180 (identified as laser control 180 in FIG. 1A). The control tower 175 may comprise laser control electronics, synchronization electronics, THz electronics, data acquisition platform and a processor (such as a CPU) for measurement and data analysis. These components are collectively referred to herein as a system controller. A display for displaying the images may be connected to the control tower 175 (display is not shown in FIG. 1A). The same display may be used for inputting acquisition parameters. This display may include a touch screen or panel.

The control tower 175 is coupled to the THz emitter 125 via one or more cables to supply power (Emitter Power 185 in FIG. 1A). This power biases the emitter 125. The control tower 175 is also coupled to the THz detector 130 via one or more cables to receive the detection result (data) (Detector Data 187 in FIG. 1A). The detection data 187 may be amplified by an amplifier 190 prior to receipt by the control tower 175. Power for the amplifier 190 may be supplied by the control tower 175.

When an ASOPS is used, the laser systems 160, 165 operate at a locked repetition rate. However, the laser systems 160, 165 have a tunable difference and repetition rates can be modulated in accordance with ECOPS operations. The synchronization electronics monitor and assure that the lasers maintain the varied or locked repetition rate and tunable difference. The control tower 175 may also comprise power supplies for the laser systems. In other systems, the controls may be different.

The example imaging system 170 also comprises a motor controller 190. The motor controller 190 is connected to the control tower 175. In an aspect of the disclosure, the motor controller 190 may be connected to control power 175 via a USB connection. The motor controller 190 controls the motors (not shown) for the motorized gimbaled mirror 115 using a programmed beam steering (an example of an acquisition parameter) for the scan in conjunction with the control tower 175 (which outputs the respective control signals). The motor controller 190 may include the power supply for the motors. The motor controller 190 receives a digital output from the control tower 175 and supplies the data signal and power to the two motors. The motor controller 190 may separately drive the two different axes (motors) via the connections. The connections are shown in FIG. 1A as Motor 1 data and power 195 and Motor 2 data and power 196. The data refers to the specific rotation for the respective motor. In some aspects, the motors for the gimbaled mirror 115 may be stepper motors.

In an aspect of the disclosure, the control tower 175 may provide separate isolated signals to the motor controller 190 for the different axes. As such, the motor controller 190 may be connected to the control tower via two separate cables.

In accordance with aspects of the disclosure, the example imaging system 170 may receive acquisition parameters input into the control tower 175. The acquisition parameters may include a resolution (pixel size). For example, the system 170 is capable of different resolutions. For example, the system 170 may have at least a first resolution and a second resolution. The pixel size for the first resolution may be 1 mm. The pixel size for the second resolution may be 0.25 mm. The resolution impacts the step size for the beam steering, e.g., difference in angles of rotations for the mirror between adjacent points of acquisition. Other acquisition parameters may include the number of time domain traces averaged per pixel, such as 10, 100, 1000, 2000 or more, and the frequency resolution and time resolution of each measurement per each pixel.

The resolution and number of data points obtained at each pixel may be target or application specific and also may be based on a desired processing of the image data, such as whether an en-face image is desired or whether a 3-D image is desired.

Additionally, once the data is acquired, the processing of the data may be based on the target and application such as whether an en-face image is desired or whether a 3-D image is desired or whether the material in the target is resonant or not. Different processing methods and techniques are known and will not be described herein in detail.

The handheld terahertz scanner described herein may be used in other setups. For example, instead of using two separate lasers as described above, the imaging system may have a single laser and incorporate a mechanical delay stage to obtain different points.

In other aspects, when PCAs are not used as the THz emitter 125 and THz detector 130, and other types are emitters are used, such as a diode, the lasers may be omitted.

FIG. 1B depicts a housing 15 for the components of the portable handheld terahertz (THz PHASR 2.0) scanner device 100 of FIG. 1A having an increased FOV, and a redesigned beam steering geometry based on a heliostat configuration, which eliminates any distortions due to the intercoupling of the scanning axes in the gimbaled motors. The scanner device 10 includes a housing 15 designed to support the gimbaled mirror and optic imaging components. The housing 15 may be made via 3-D printing using plastic. However, in other aspects of the disclosure, the housing may be made using other methods such as but not limited to injection molding. While described in more detail in commonly-owned, co-pending U.S. patent application Ser. No. 17/438,630, housing includes a base 20, a motor cover 24, an optional mounting panel 26 for mounting the device to a wall or frame structure, and a spacer 28 that may be mounted on the bottom of the base 20. In an embodiment, the base 20 also has an THz emitter cable channel 162 and a THz detector cable channel 164 extending from a common cable opening. The motor cover 24 may be mounted on top of the base 20 and have respective motor cable openings through which both Motor 1 and Motor 2 Data and power cables 195,196 extend. A handle 24 can be located on the motor cover 24. Bottom and top refer to directions in the orientation that the handheld terahertz scanner will be used. The base may have a handle 30. The handle 30 may extend from a wall of the housing. In an aspect of the disclosure, the handle 30 is cylindrical.

FIG. 2A depicts a simplified model 200 of the beam steering geometry in PHASR Scanner 2.0 of the present disclosure including the mirror gimbal layout 115. Rather than intercoupling thwo gimbal axes as in the gimbol mirror layout of the prior PHASR Scanner 1.0, to improve the FOV range, the mirror gimbal layout is redesigned as shown in FIG. 2A. FIG. 2A particularly depicts the geometry of the PHASR Scanner 2.0's beam steering. The re-designed mirror gimbal layout scheme 200 of FIG. 2A is based upon heliostat instruments used in astronomy to reflect light from the sun as it moves through the sky to a fixed point.

In particular, The Scanner 2.0 design 200 of FIG. 2B adapts the scanning mechanism's orientation to reduce the axial coupling. Instead of a single off-the-shelf gimbal, a pair of motors are stacked in a “daisy-chained” configuration. A rotation stage controlling the azimuthal axis is fastened directly to the scanner housing. The elevation angle is controlled by a motorized goniometer 220 attached to the rotation stage. A 3D printed mirror mount 215 biased by 45° about the elevation axis is used to properly locate the mirror 115 for scanning.

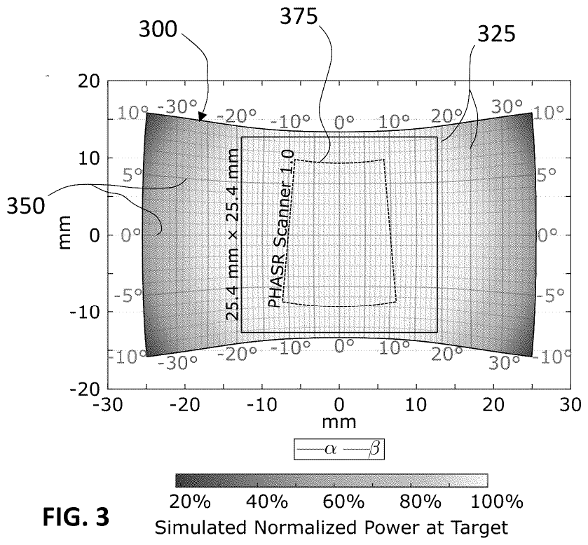

FIG. 2B shows the model gimbal 250 that demonstrates this orientation. In particular, FIG. 2B depicts a simplified representation of the gimballed mirror in PHASR 2.0 showing the azimuthal axis, 265, aligned with the incident beam and elevation axis, 270, perpendicular to it. Note again the effect that rotating about the azimuthal axis has on the angle between the incident beam and the elevation axis. In this design, the outer azimuthal axis is collinear with the incident beam and as such, the elevation axis remains perpendicular to the incident beam at any azimuthal position. Here, the angles of rotation to direct light to a specific position on the target is based on a rotational relationship between the azimuthal axis and the elevation axis and properties of the lens. This provides the larger and significantly more rectilinear FOV as shown in FIG. 3.

In particular, FIG. 3 shows a resultant scanning pattern 300 from this geometry. Vertical lined grids 325 and horizontal line grids 350 represent coordinates of the angular deflection of the scanning mirror, a and B about its azimuthal and elevation axes, respectively. The dashed line 375 shows the FOV accessible with the previous version of the scanner Scanner 1.0 and the solid black line shows the typical scanning area of 25.4×25.4 mm2 (1×1 in.2). The color scale shows the normalized incident power at the target as determined by ray-tracing simulation.

For comparison, as shown in the black dashed line outline 375 of the PHASR Scanner 1.0 FOV 375, the vertical scan range, limited by the +10° travel of the goniometer, is approximately 27 mm at the center, expanding slightly at larger horizontal positions. The color within the scanning area in FIG. 3 shows the simulated normalized power at the target calculated via ray-tracing. The circular profile shows how the primary limiting factor of the horizontal scan range is the diameter of the f-θ lens which provides approximately a 40-mm range.

### Heliostat Beam Scanning Algorithm

To demonstrate the decoupling of the imaging axes of rotation in the heliostat design, there is derived the scanning coordinate system from the axial deflections. There is defined the z-axis to be aligned antiparallel with the optic axis of the f-θ lens, and the x- and y-axes as shown in FIG. 2A. A vector perpendicular to the face of the mirror 115 then has the direction according to equation 1) as follows:

$$\hat{m} = ( \begin{matrix}cos ( β - 45 ° ) sin ( α ) \\ sin ( β - 45 ° ) \\ - cos ( β - 45 ° ) cos ( α )\end{matrix} ) , \qquad ( 1 )$$

where α and β are the angles rotated by the azimuthal and elevation motors, respectively, and defined in FIG. 2B. That is, the mirror points in a direction corresponding to a simple spherical coordinate system with azimuthal angle about the y-axis and elevation measured in either direction from the xz-plane. The collimated THz beam is then described by the incident and reflected vectors, respectively, according to equation 2) as follows:

$$\begin{matrix}{\hat{b}}_{i n} = ( \begin{matrix}0 \\ 1 \\ 0\end{matrix} ) , & {b}_{o u t} = ( \begin{matrix}x \\ y \\ - f\end{matrix} )\end{matrix} , \qquad ( 2 )$$

where (x,y) is the location of the beam at the lens plane. Reflecting −bᵢₙ about m to get the direction of bₒᵤₜ and scaling such that the z coordinate is equal to −f, so that x- and y-coordinates represent the location at the lens plane, it can be seen that

$${b}_{o u t} = ( \begin{matrix}f tan ( α ) \\ f sec ( α ) tan ( 2 β ) \\ - f\end{matrix} ) = f sec ( α ) ( \begin{matrix}f sin ( α ) \\ tan ( 2 β ) \\ - cos ( α )\end{matrix} ) . \qquad ( 3 )$$

Here equation (3) shows that at the lens plane, the x-coordinate is only dependent on f and α, and the value h=f sec α=\sqrt{x²+z²} is the distance to the lens plane at azimuthal angle α. Similarly, the y-coordinate is only dependent on h and β. That is, the angle within the xz-plane is determined only by a and the angle away from the xz-plane is determined only by β.

The basic scanning algorithm for this design is then as follows: The face of the mirror 115 must point in the direction bisecting the incident and reflected beams:

$$m = ‖ {\hat{b}}_{i n} ‖ {b}_{o u t} + ‖ {b}_{o u t} ‖ ( - {\hat{b}}_{i n} ) = ( \begin{matrix}{m}_{x} \\ {m}_{y} \\ {m}_{z}\end{matrix} ) . \qquad ( 4 )$$

The axes of the gimbal must rotate to according to equations 5) as follows:

$$\begin{matrix}α = arctan ( \frac{{m}_{x}}{- {m}_{z}} ) , & β = arctan ( \frac{{m}_{y}}{\sqrt{{m}_{x}^{2} + {m}_{z}^{2}}} ) + 45 ° .\end{matrix} \qquad ( 5 )$$

The previously demonstrated linear correction can be applied to account for slight deviations due to the f-θ lens. This method is general for heliostat scanning over f-θ lenses. Variations on this design using different lenses might provide better performance for different applications, albeit with some tradeoffs. For instance, a lens with a larger focal length provides a greater field of view for the same angular range of travel at the gimbal, but at the cost of a larger spot size at the focus, reducing the spatial resolution of the device. The particular f-θ lens used here has been developed to suit the needs of a compact scanner. Thus, the vertical scan range of the PHASR Scanner 2.0, limited by the ±10° travel of the goniometer, is approximately 27 mm at the center, whereas the horizontal scan range is limited only by the lens area (e.g., here to approximately 40 mm).

### ECOPS Measurements Using ASOPS Hardware

The imaging rate of the prior Scanner 1.0 was limited by the measurement speed of the commercial ASOPS system used for generation and detection of THz pulses. Although faster than using a mechanical delay line, the THz-TDS acquisition rate was slower than speeds provided by the ECOPS technique. ECOPS trace acquisition rates of 2.5 kHz, 8 kHz and even as high as 60 kHz have been demonstrated, though with THz time-axis ranges limited to less than about 20 ps at those speeds. Imaging systems using ECOPS technique have been reported with operating speeds of 1000 trace/s. Also, point measurements of sample layer thickness have been acquired at 1600 Hz rates with 200 ps of range. Both ASOPS and ECOPS use two femtosecond lasers to respectively generate and sample the temporal waveform of the THz electric fields.

In both techniques, the difference in repetition rate of the two lasers causes the sampling laser to progressively record sequential THz pulses in time, building a representative time-domain acquisition. The laser generating the THz pulses is referred to herein as “Laser A,” which has a constant repetition frequency fᵣₑₚ and will thus produce THz pulses separated by a period of Tᵣₑₚ=1/fᵣₑₚ. The laser sampling the THz pulses is called “Laser B” and has its repetition frequency set to fᵣₑₚ−Δf, where Δf is small compared to fᵣₑₚ. In general, the difference frequency Δf can be set by the user and is dependent on time, t. As a result, the THz pulse samples occur at a period of 1/(fᵣₑₚ−Δf). Assuming no variation in the beam path, each of these THz pulses is essentially identical at the detector so the different repetition periods of the two lasers mean that, in comparison to the previous sampling location of the THz pulse, each subsequent sample will be delayed by a value Δτ according to equation 6) as follows:

$$Δ τ ( t ) = \frac{1}{{f}_{rep} - Δ f ( t )} - \frac{1}{{f}_{r e p}} \approx \frac{Δ f ( t )}{{f}_{r e p}^{2}} , \qquad ( 6 )$$

where values of τ refer to the effective time axis intervals of the THz pulse and are usually in picoseconds. The actual sampling interval in lab time, t, is Tᵣₑₚ=1/fᵣₑₚ and is equal to the period of the femtosecond laser pulses. Each successive pulse from Laser B will sample the corresponding THz pulse generated by Laser A at a time-point shifted by Δτ. Starting at an arbitrary sampling time τ(0)=Δτ₀ at time t=0, the effective sample time at t is given according to equation 7) as follows:

$$τ ( t ) = {τ}_{0} + {\sum }_{n = 0}^{⌊ t \times {f}_{r e p} ⌋} \frac{Δ f ( n / {f}_{r e p} )}{{f}_{r e p}} \times \frac{1}{{f}_{r e p}} \qquad ( 7 )$$

where n=└t×fᵣₑₚ┘ is the integer number of laser pulses that have occurred since t=0. The separated factor of 1/fᵣₑₚ emphasizes the fact that this is, in essence, a Riemann sum with its step size defined by the repetition interval of the laser. Thus, the transform between time and the sampling location can be approximated by the integral of the difference frequency over time.

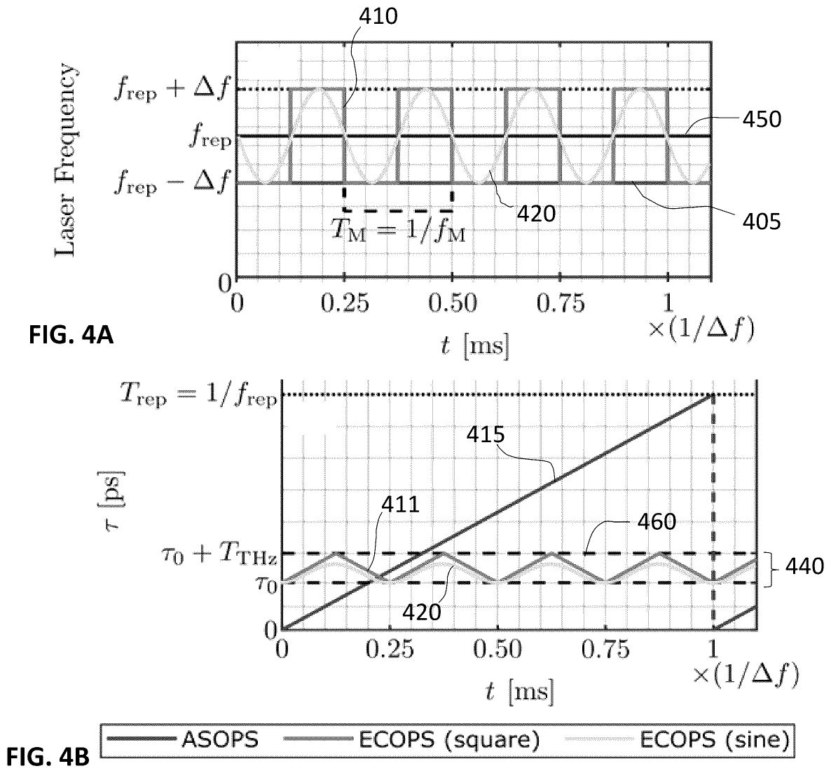

Referring to FIGS. 4A-4B, there is provided a conceptual depiction of the difference between the ASOPS (lines 405, 415) and the ECOPS techniques using square wave modulation (lines 410) and sinusoidal wave modulation (lines 420). FIG. 4A depicts the repetition rate of the two lasers, where Laser A is represented by the solid line 450 for both ASOPS and ECOPS. The repetition rate of Laser B is constant in ASOPS (e.g., line 405), whereas it is modulated in ECOPS with a square function 410 or sinusoidal function 420. In FIG. 4B, the time domain sampling instances, as given by Eq. (7), are depicted for both techniques. Dashed lines 460 indicate the portion of interest in the time domain sampling window in a typical THz-TDS measurement. The time axis, shared between graphs of both FIG. 4A and FIG. 4B, shows one 1/|Δf| sampling period, i.e., the time required to record a single ASOPS trace, in laboratory time. In practice, the magnitude of Δf is not the same between the two techniques, and a sinusoidal function of much higher frequency is used to drive ECOPS.

More particularly, in ASOPS measurements, illustrated in FIG. 4B, Δf is kept constant and t will increase by the same amount per pulse. The direction in which the sampling progresses depends on which laser has a higher repetition rate, i.e., it depends on the sign of Δf. If Laser B has a lower repetition frequency, as depicted at 405 in FIG. 4A, the sampling can be said to be in the “forward” direction as each subsequent sample is associated with a later time in the THz signal, as shown in FIG. 4B. If the frequency of Laser B is higher, the sampling will occur in the opposite, “backwards,” direction. For ASOPS measurement in either direction, after one full period of the difference frequency, 1/|Δf|, the accumulated sample time will equal that of a full period of the laser repetition, that is, τ(1/|Δf|)−τ₀=Tᵣₑₚ, and thus samples covering the full THz pulse will have been acquired. To improve the signal to noise ratio, SNR, multiple sequential acquisitions are then typically averaged to build a single THz-TDS trace, so the total time per trace is the number of averages multiplied by 1/|Δf|.

However, ASOPS measurements are not time-efficient because in every acquisition event the entire Tᵣₑₚ on the order of 10 ns, is recorded but only the relevant THz-TDS measurements range, typically on the order of 100s of ps, is retained. This effect is illustrated in FIG. 4B by the range between the dashed lines 460. Thus, the majority of the period of ASOPS is spent sampling timepoints outside of the range of interest. ECOPS improves the measurement speed by only sampling a small range of interest.

The ECOPS technique can be understood as ASOPS measurement with an alternating Δf, such as the illustrations shown in FIG. 4A. As a result of the modulated Δf value, instead of sampling the entire 1/|Δf| period, Laser B repetitively samples in both forward and backward directions over only a small section of the available period as shown as line 411 in FIG. 4B. If the frequency of the modulation is f_{M}, single-shot THz-TDS traces can be acquired at 2f_{M} since data can be recorded in both directions. However, unlike ASOPS, which can sample any-sized section of the entire Tᵣₑₚ period of the THz waveform, ECOPS's measurement range, T_{THz}, is linked to the speed through both Δf and f_{M}. Thus, while the THz acquisition window and its starting point, To, can be adjusted in ASOPS by simply recording a different section of the 1/|Δf| period, for ECOPS this requires more coordinated adjustment of the modulation parameters.

Despite these differences, the two techniques can be implemented using the same equipment. The variation in Δf is created by taking advantage of the existing ASOPS hardware. The repetition rate of each of the lasers is controlled by the length of the laser cavity using stepper motors and piezoelectric actuators for coarse and fine adjustment of the laser cavity. A feedback system monitors the pulse rates and compares them to a reference oscillator and then adjusts the cavity length accordingly in real time. In one embodiment of the system, the reference for Laser B is generated by a Keysight 33500B Series waveform generator, allowing a user to select different values of Δf for different speeds of ASOPS. ECOPS operation is achieved by modulating the frequency of this reference and relying on the same feedback system to correctly adapt the repetition rate.

In an embodiment, if the target Δf is modulated too aggressively, the system can introduce errors in the repetition rate or will lose phase-locking between the two lasers entirely. For this reason, a sinusoidal modulation is used as illustrated by the traces 420 in FIGS. 4A, 4B, which more smoothly varies the difference frequency than a square wave 410. Likewise, to maintain phase-locking in the system, there is used a peak ECOPS Δf smaller than the typical Δf used in ASOPS. However, the varying magnitude of the difference frequency produced by a sinusoidal modulation results in a time-dependent sampling rate of the THz time-domain demonstrated by the curved trace 420 in FIG. 4B. This is further complicated by the imperfect system response to the modulated reference frequency f_{M}. The combined effects of these present transiently as timing drift and persistently as a distortion to the expected sampling rate of the THz signal, both of which must be accounted for. As a shorthand, the ECOPS modulation parameters are specified by the modulation frequency and peak frequency differences. For example, “f_{M}=1000 Hz, Δf=±32 Hz” is represented as a nominal modulation of the form Δf=(32 Hz) sin (2πt(1000 Hz)). In contrast, ASOPS measurements, which have a constant difference frequency, will be indicated just by that value, e.g., Δf=100 Hz. As shown in the example laser frequency plot of FIG. 4A, in the time 1/Δf, the ASOPS technique of fixed Δf would obtain one THz-TDS sample measurement, while the example ECOPS square wave modulation of Δf in the time T_{M}=1/f_{M} period would result in obtaining two samples.

It is the case that each pixel of the image there is acquired a time trace, and each pixel value is a waveform as a function of time which can have distortions due to the laser operation mechanisms, e.g., when the laser is run at high speeds. The depiction in FIGS. 4A, 4B can be thought of a stretching and compressing of the time axis which introduce non-linearities in the time domain and negatively impact measurement accuracy. Thus, the present disclosure provides a method to sample the time domain using ECOPS, and, in addition, model and correct the non-linear effects to ensure a linear time axis to increase measurement accuracy when speed of time-domain acquisition is increased, e.g., the speed at which the Δf changes is 1.3 kHz, i.e., the modulation frequency of Δf, the laser performs twice as many as modulation frequency, or 2600 traces per sec (or greater) over a 100 picosecond time-domain sampling range.

### Timing Drift

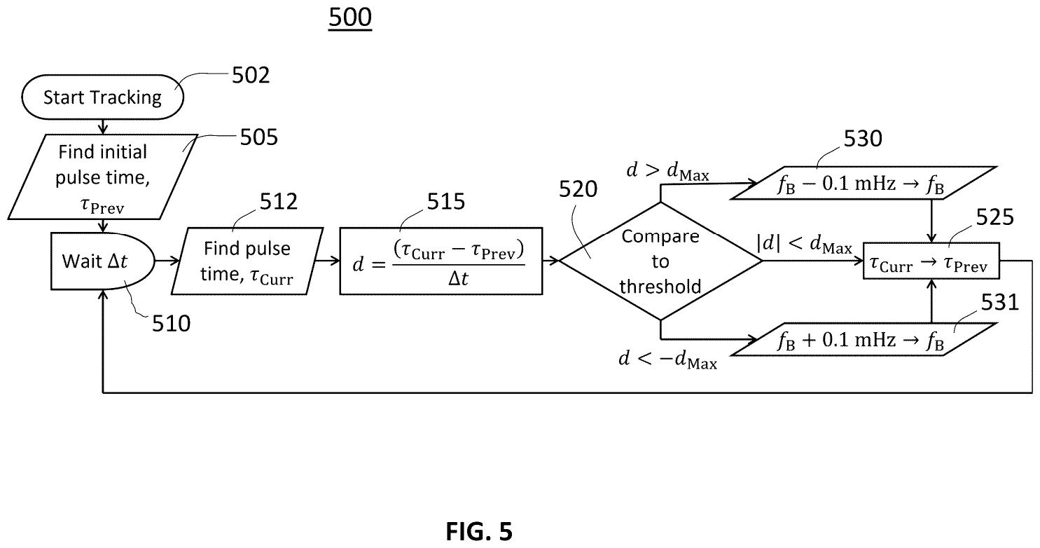

Drift occurs if the system responds differently to the two forward and backward directions of time-domain scanning, e.g., through a hysteresis in the piezo. In that case, the two directions will cover different amounts of t, leading to an apparent drift of the THz signal due to the drift of the ECOPS sampling range. Left unchecked, this drift will quickly cause the region of interest to shift out of the scanning window. To counteract this effect, a small offset (typically on the order of tens of mHz) to the base repetition rate of probe laser B, f_{B}, is required to bias the modulation by the same amount opposite to the drift. However, in the system, using a constant offset value is insufficient as the drift varies over time, as much as 5 ps/s within minutes. To address this issue, one embodiment implements a state control model for real-time drift compensation described by the method depicted in FIG. 5. In order to properly track the drift, the method must find and lock on to a feature (such as the peak of a THz pulse) known to be stationary. For rough-surface or malleable targets such as liquid or skin, the flat imaging window 145, shown in FIG. 1A, provides an ideal reflection reference from the air-window interface. Since the f-θ lens provides a constant phase at its focus over the entire planar field of view, there is no additional compensation for scanning location needed. The difference of the current apparent time location of this feature, τ_{Curr}, from the location measured some amount of time, Δt, previously, τ_{Prev}, provides the drift, d, of the ECOPS time window. A small adjustment to the frequency offset is made to compensate any time the window drift is above a certain threshold, d_{Max}, in either direction. Once engaged, this compensation actively counters the majority of the drift in real-time. Any remaining variation can be classified as jitter, which contributes to the measurement noise.

FIG. 5 depicts a state model drift compensation method 500. Step 502 begins the tracking of the drift. At 505, the it obtained the initial pulse time, τ_{Prev}. After waiting the amount of time, Δt, at 510, the process continues to determine the current apparent time, τ_{curr} at 512. Then, at 515, a computation of the drift Drift, d, is performed which is calculated as the change in measured feature location (τ_{Curr}−τ_{Prev}) over some amount of time, Δt. Then, continuing to 520, a determination is made as to whether the calculated drift d is greater than a pre-determined threshold value d_{Max}. If the magnitude of d is less than the threshold d_{Max}, then the process sproceeds to 525 where the value τ_{Prev} is set to the τ_{Curr} value (i.e., (τ_{Curr}→τ_{Prev}). If, at 520, it is determined that the magnitude of d is greater than a threshold, d_{Max}, then a small corresponding correction is made to the base repetition rate of Laser B, f_{B}. For example, the value f_{B} is set to the previous f_{B}−0.1 mHz. Alternately, at 520, if it is determined that the magnitude of d is greater than a threshold, −d_{Max}, then the process proceeds to 531 where the small corresponding correction made to the base repetition rate of Laser B, is, for example, f_{B} is set to the previous f_{B}+0.1 mHz.

### Nonlinear Time-Domain Sampling and its Correction

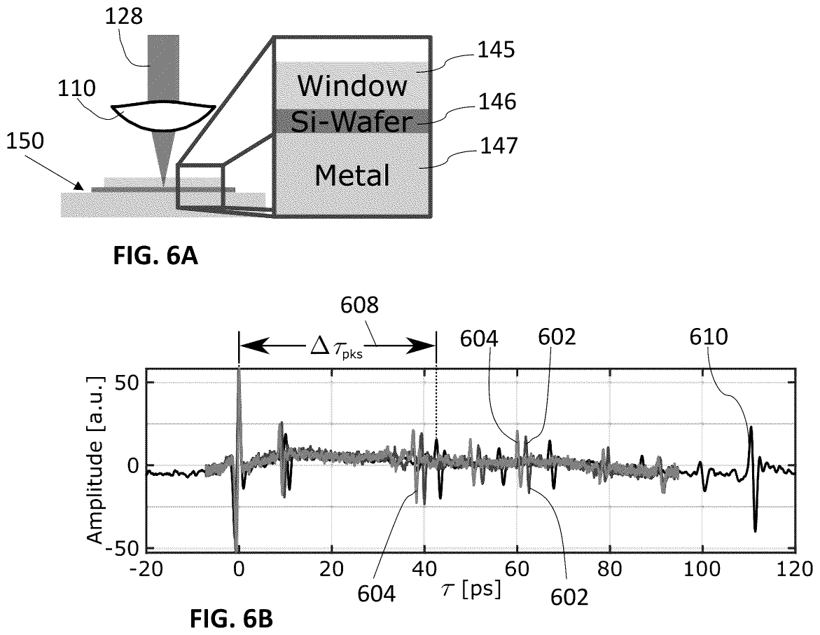

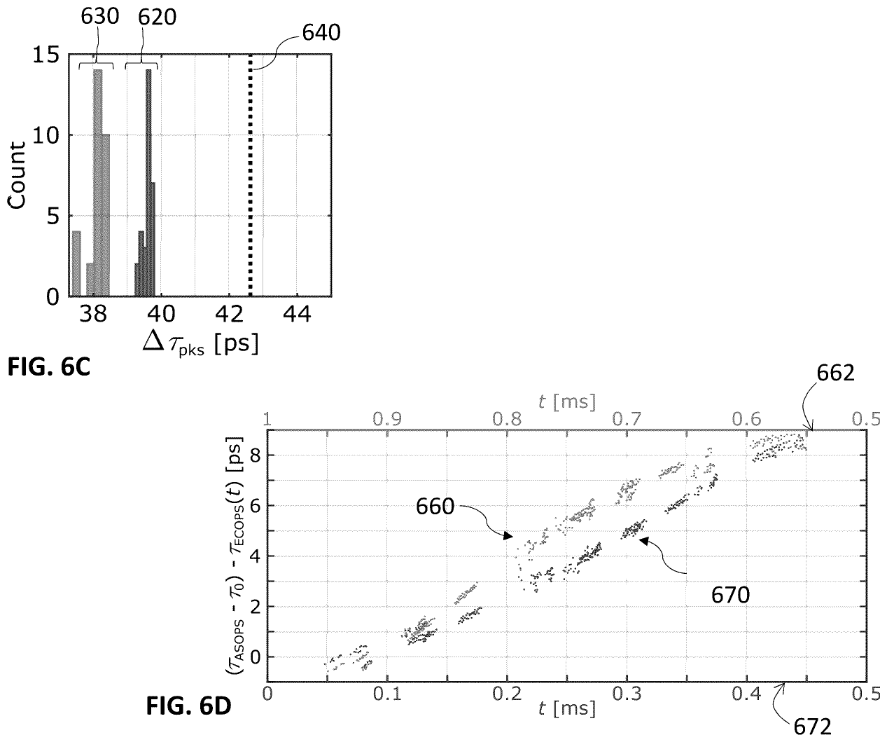

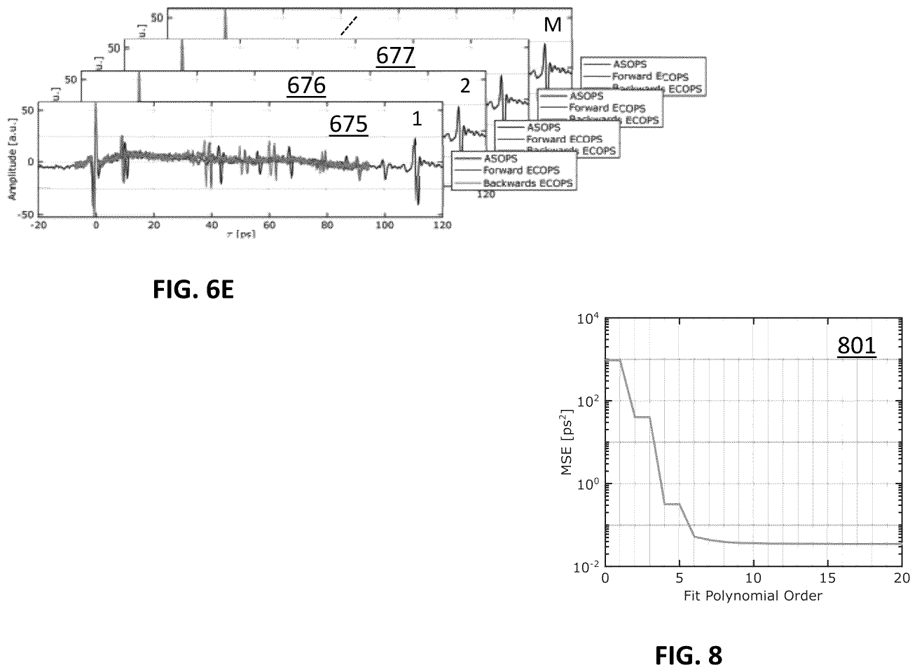

In addition to the drift, other time-axis distortions are present as a result of the electronic and mechanical systems response to the frequency modulation. For example, any inaccuracy of the modulation electronics, mechanical responses of the piezos to the electronic waveform, or drift correction will modify the modulation from the nominal sinusoid and thus deviate the sampling from the expected points. The extent of this distortion is illustrated by measurements from a multi-layer reference target, such as shown in FIG. 6A.

FIG. 6A particularly illustrates the multi-layer reference target used for providing constant sampling points in the time-domain. As shown in FIG. 6A, there is provided a portion of the Scanner 2.0 system the laser beam scan signal 128 shown impinging on the target sample 150 through the f-θ imaging lens 110. As shown, the target sample 150 is a multi-layered stack or sandwich of known thickness, the layered stack including the transparent imaging window 145 atop a thin semiconductor wafer (e.g., a transparent Silicon wafer) 146 a top a formed metal layer 147. As shown in FIG. 6A, TDS point measurements of the thin wafer of silicon 146, sandwiched between the imaging window 145 and a reflecting metallic back layer 147 provides many distinct pulses due to the Fabry-Perot reflections. The relative timing of these “landmark” features allow for simple comparison between ECOPS signals and an ASOPS or “ground truth” reference measurement of the same location on the multi-layer sample.

FIG. 6B depicts a plot of the detected signal amplitude (a.u.) along the Y-axis against time τ (in ps) along the X-axis. The plot of FIG. 6B depict representative time-domain signals when using the ECOPS time axis (f_{M}=1000 Hz, Δ_{f}=±32 Hz, 50 avg.) in the forward direction depicted by signal 602, and in the backward direction depicted by signal 604 as compared to the reference ASOPS signal 610 of the same target (Δf=100 Hz, 100 avg.). Assuming no distortions, the pulses depicted in the signals 602, 604 and reference 610 should overlap, i.e., arrive at the same time. That is, ideally, the locations of the peaks in the ECOPS signals are associated with the same peaks in the ASOPS signal. FIG. 6B particularly illustrates the ECOPS time axes generated by Eq. (7), τ_{ECOPS}(t), using the expected modulation function. This basic model does not result in the correct time axes and notably the timing error is not the same for both directions of the ECOPS sampling. For instance, note the time interval 608 labeled by ΔTₚₖₛ in FIG. 6B. As measured by the ASOPS reference, the later peak arrives 42.62 ps after the first.

FIG. 6C depicts, for the example system depicted in FIG. 6A providing pulses shown in FIG. 6B, a distribution of the measured delay between the two pulses marked in FIG. 6B over 30 traces from each of the ECOPS (forwards and backwards) directions. In particular, FIG. 6C shows a plot of the distributions of the measured delay between peaks particularly as a count along the Y-axis against time delay between the pulses labeled as Δτₚₖₛ (ps) along the X-axis. For the forward ECOP direction the distribution is shown as bars 620 and for the backward ECOP direction the distribution is shown as bars 630. The dotted line 640 depicts the ASOPS value. As shown in FIG. 6C, this difference is consistently underestimated by the ECOPS signals.

FIG. 6D depicts a comparison of the difference between the measured ASOPS and ECOPS locations (adjusted for different τ₀ values) of the time-domain reflection peaks in the forward (lower X-axis 672) and backward (upper X-axis 662) for all 30 ECOPS datasets. FIG. 6D shows the time-dependent difference in the ECOPS location of the landmark peaks from the same observed ASOPS locations, τ_{ASOPS}, offset by the different τ₀ values for each trace. In the case of no distortions, if the ECOPS measurement perfectly reproduced the ASOPS signal, these points would fall at 0 for all t. Instead, the non-zero slopes of the two sets indicate that the scaling provided by Eq. (7) didn't capture the dynamic response of the electrical and mechanical hardware. The differences in the response to each direction of modulation is also made clear by in the plot depicting forward and backwards ECOPS measurements using backwards ECOPS data points 660 along the corresponding time axis 662 and forward ECOPS data points 670 plotted along the corresponding time axis 672.

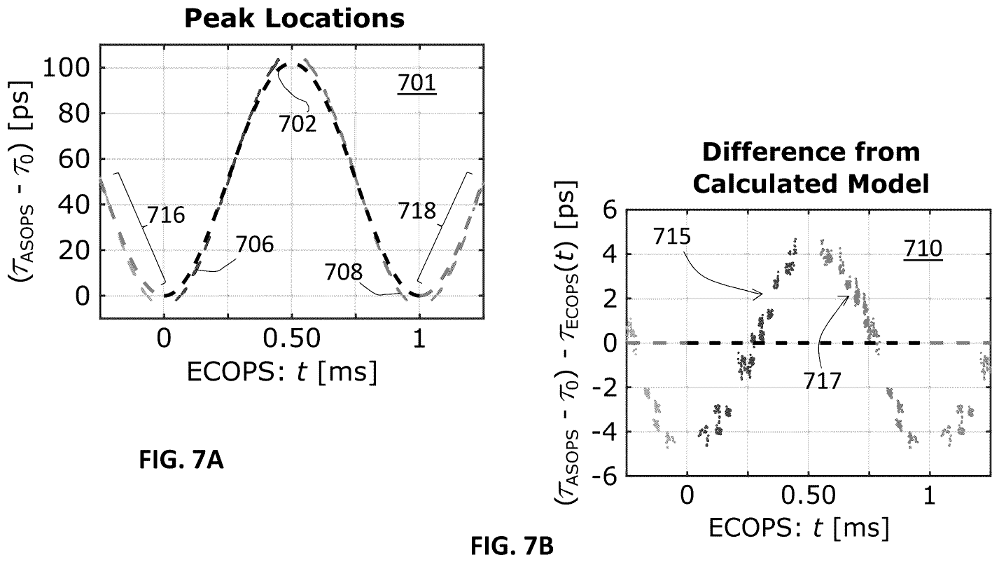

The full extent of the timing error can be seen in FIGS. 7A and 7B, with FIG. 7A showing a plot 701 comparing the expected time axis function calculated from Eq. (7), dashed line 702, to the actual corresponding ECOPS time-domain peaks in both forward direction, depicted by dashed line 706, and backwards direction, depicted by dashed line 708. The respective faded copies 716, 718 of the data points on either side of the 0 to 1/f_{M} period provide context to the behavior of the model near the respective start and end of each measurement cycle. More particularly, FIG. 7A depicts a correspondence of the location of the time domain peaks between the ECOPS forward 706 and backward 708 directions and the ASOPS signals compared to the results calculated from Eq. (7) assuming that (τ_{ASOPS}−τ₀)=τ_{ECOPS}(t), i.e., dashed line 702. The data presented here is the same as those shown in FIG. 6A (f_{M}=1000 Hz, Δf=±32 Hz, 50 avg.)

FIG. 7B is a plot 710 depicting the difference from the calculated model, more clearly showing the asymmetry of the trend between the ECOPS forward direction 715 and the ECOPS backward direction 717. The trend 715 shown in FIG. 7B results in time-domain error values of up to 5 ps. The peak locations in FIG. 7A and FIG. 7B in the example depicted were collected from 30 separate time-domain acquisitions.

This method of comparison provides an approach for a time-axis correction using empirical measurements of the Fabry-Perot reflections in the time-domain signals. A similar method can be used for finding the time-axis scaling factor. Since the reflections are distinct and deterministic events in the time domain, they can be used for discrete sampling of a transformation from t to τ. In other words, a function describing the transformation between the ECOPS locations of the “landmark” features, such as the peaks, and the corresponding features in an ASOPS acquisition provides a time-axis calibration. That is, using the ASOPS measurements (reflected pulse signals) as the ground truth (signal 610, FIG. 6B) a comparison is made between every single paired ECOPS forward and backwards reflected pulse signals 602, 604 against the corresponding pulse signal in the ASOPS signal. Alternatively, the comparison can be made between every single paired ECOPS forward and backwards reflected pulse signals 602, 604 and a corresponding expected or determined “feature” location (e.g., signal peak) obtained from any ground truth signal or prior reference measurement, e.g., such as obtained from knowing the expected time of the pulses given the parameters of the sample stack such as layer thicknesses, layer materials and known properties, e.g., absorption, diffraction. The differences between the peak locations of ground truth signals and those of each paired ESOPS forward and backwards reflected pulse signals as shown in FIG. 6D can be used to generate a model or transform that can be used to calibrate the ECOPS measurements and correct for the non-linearities present between these signal sets along the time axis as the scanner acquisition speed increases.

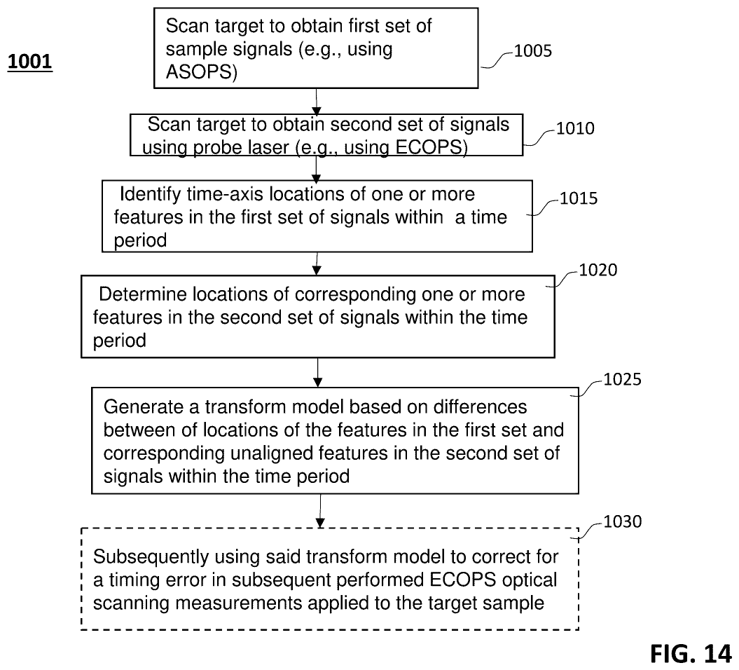

FIG. 14 depicts one embodiment of a calibration method 1001 for calibrating the PHASR 2.0 THz handheld scanner using ASOPs optical scanning hardware making ECOPs optical scanning measurements capable of imaging at an increased field of view at increased sampling acquisition rates, e.g., at least 2000 traces (temporal waveforms) per second. At a first step 1003, there is depicted the scanning of a target or reference sample, such as the layered stack sample shown in FIG. 6A. The THz scanning at 1005 implements the ASOPS scanning measurement or acquisition to obtain a first signal set of reflected pulses from the target-namely a first signal having identifiable time-domain “landmark” features, e.g., signal reflection peaks, within a time period. This ASOPS signal can represent a ground truth signal. Then, at 1010, there is depicted the subsequent scanning of the target or reference sample by implementing the ECOPS scanning measurements to obtain reflected pulse signal acquisitions from the target that result in a second signal set having similar time-domain features, e.g., signal reflection peaks, corresponding to the time-domain reflection peaks of the ground truth signal, but at different time domain locations within the time period. These features are identifiable in each of the paired ECOPS forwards and backwards reflected pulse signals. Then at 1015, FIG. 14, the method includes identifying the time-axis locations of one or more landmark features in the first set of signals, i.e., in the ground truth signal within the time period. Continuing at 1020, FIG. 14, the method includes determining the time domain locations in each of the paired ECOPS forwards and backwards reflected pulse signals that correspond to the identified landmark features in the first set of signals, i.e., in the ground truth signal within the time period. Then, at 1025, FIG. 14, the scanner generates a transform model based on differences between the identified locations of the landmark features in the first signal set, i.e., the ground truth signal, and the corresponding unaligned location of the same features in the second set of signals including the paired ECOPS forwards and backwards reflected pulse signals within the period.

In an embodiment, the generating of the transform model at step 1025, FIG. 14 includes approximating this transform model for an individual acquisition using a polynomial equation of order N given according to equation 8) as follows:

$$τ ( t ) - {τ}_{0} = {\sum }_{P = 1}^{N} {C}_{P} {t}^{P} , \qquad ( 8 )$$

where C_{P} are the coefficients of the P^{th} polynomial term. In the method, the first step includes labeling the landmark features a, b, c, . . . and associate their ECOPS locations in lab time: tₐ, t_{b}, t_{c}, . . . with their ASOPS time-locations: τₐ, τ_{b}, τ_{c}, . . . and then determining the set of C_{P} values and τ₀ using a least-squares fitting algorithm produced by numerically solving the matrix equation, given according to equation 9) as follows:

$$[ \begin{matrix}{( {t}_{a} )}^{N} & {( {t}_{a} )}^{N - 1} & … & {t}_{a} & 1 \\ {( {t}_{b} )}^{N} & {( {t}_{b} )}^{N - 1} & … & {t}_{b} & 1 \\ {( {t}_{c} )}^{N} & {( {t}_{c} )}^{N - 1} & … & {t}_{c} & 1 \\ ⋮ & ⋮ & ⋮ & ⋮ & ⋮\end{matrix} ] = [ \begin{matrix}{C}_{N} \\ {C}_{N - 1} \\ ⋮ \\ {C}_{1} \\ {τ}_{0}\end{matrix} ] = [ \begin{matrix}{τ}_{a} \\ {τ}_{b} \\ {τ}_{c} \\ ⋮\end{matrix} ] . \qquad ( 9 )$$

In an embodiment, the initial sampling point, τ₀, depends on the starting point of the window thus in general will be different for each acquisition. The polynomial coefficient terms, C_{P}, model the shape of the ECOPS time sampling and, excluding jitter, are expected to be the same for each acquisition. It is understood that a different fitting method using sinusoids can be used rather than polynomials, e.g., depending upon the sample and the type of time-axis distortion prevalent. The use of a polynomial correction is just one example and another mathematical relationship such as sinusoidal, etc., can be equally appropriate and used in other examples.

The accuracy of this approximation may be limited by the number and distribution of sampling points used to generate the fit. Thus, in a further embodiment as shown in FIG. 7C, instead of generating the transform model based on the peak locations of a single paired (forward and backwards) ECOPs scan to the ground truth signal, e.g., a single ASOPS measured reference peak locations on the time axis, the number of reference points can be further increased by using multiple acquisitions with different τ₀ values, and thus different time window locations. That is, as shown in FIG. 6E, there are measured “M” multiple pairs of ECOPS (forwards and backwards) signals 675, 676, 677, . . . , with each paired ECOPs signal being shifted forward or backward in time. Thus, in the alternate embodiment, at 1025, FIG. 14, each of the multiple ECOPS signal measurement starts at a different time location and produces a location of reflections at different times (t) which can be used to formulate a more accurate model transform using the polynomical fit equation (10). That is, in order to find the correct coefficients C_{N}, C_{N-1}, . . . , C₁ for all acquisitions, there is fit a system of equations, in which the constant terms (0^{th} order) are unique to acquisitions of the different time windows, but non-constant (1^{st} and greater order) polynomial terms remain the same. That is, for M different ECOPS acquisitions, the method extracts the time-locations, t_{i,m} and τ_{i,m}, where i=a, b, c, . . . and m=1, 2, . . . , M, for all “landmarks” time sampling locations. The system of equations can be represented by the matrix equation given according to equation 10) as follows:

$$a . [ \begin{matrix}{( {t}_{a , 1} )}^{N} & {( {t}_{a , 1} )}^{N - 1} & … & {t}_{a , 1} & 1 & 0 & 0 & … & 0 \\ {( {t}_{b , 1} )}^{N} & {( {t}_{b , 1} )}^{N - 1} & … & {t}_{b , 1} & 1 & 0 & 0 & … & 0 \\ {( {t}_{c , 1} )}^{N} & {( {t}_{c , 1} )}^{N - 1} & … & {t}_{c , 1} & 1 & 0 & 0 & … & 0 \\ ⋮ & ⋮ & ⋱ & ⋮ & ⋮ & ⋮ & ⋮ & ⋱ & ⋮ \\ {( {t}_{a , 2} )}^{N} & {( {t}_{a , 2} )}^{N - 1} & … & {t}_{a , 2} & 0 & 1 & 0 & … & 0 \\ {( {t}_{b , 2} )}^{N} & {( {t}_{b , 2} )}^{N - 1} & … & {t}_{b , 2} & 0 & 1 & 0 & … & 0 \\ {( {t}_{b , 2} )}^{N} & {( {t}_{c , 2} )}^{N - 1} & … & {t}_{c , 2} & 0 & 1 & 0 & … & 0 \\ ⋮ & ⋮ & ⋱ & ⋮ & ⋮ & ⋮ & ⋮ & ⋱ & ⋮ \\ {( {t}_{a , M} )}^{N} & {( {t}_{a , M} )}^{N - 1} & … & {t}_{a , M} & 0 & 0 & 0 & … & 1 \\ {( {t}_{b , M} )}^{N} & {( {t}_{b , M} )}^{N - 1} & … & {t}_{b , M} & 0 & 0 & 0 & … & 1 \\ {( {t}_{c , M} )}^{N} & {( {t}_{c , M} )}^{N - 1} & … & {t}_{c , M} & 0 & 0 & 0 & … & 1 \\ ⋮ & ⋮ & ⋮ & ⋮ & ⋮ & ⋮ & ⋮ & ⋮ & ⋮\end{matrix} ] \times [ \begin{matrix}{C}_{N} \\ {C}_{N - 1} \\ ⋮ \\ {C}_{1} \\ {τ}_{01} \\ {τ}_{02} \\ {τ}_{03} \\ ⋮ \\ {τ}_{0 M}\end{matrix} ] = [ \begin{matrix}{t}_{a , 1} \\ {t}_{b , 1} \\ {t}_{c , 1} \\ ⋮ \\ {t}_{a , 2} \\ {t}_{b , 2} \\ {t}_{c , 2} \\ ⋮ \\ {t}_{a , M} \\ {t}_{b , M} \\ {t}_{c , M} \\ ⋮\end{matrix} ] \qquad ( 10 )$$

Solving equation (10) gives the single set of coefficients for the mapping, C_{N}, C_{N-1}, . . . , C₁ as well as the τ₀'s. Furthermore, simultaneous fitting to multiple M acquisitions reduces the impact of jitter on the calculated value of the coefficients.

While this transformation could be applied independently for each direction of ECOPS scan, alternatively it is found that this is best done using ECOPS measurements which have been “unwrapped”, as in FIGS. 7A, 7B to contain both the forward and backwards sampled signals as they were recorded. That is, the fitting method is applied to both the points 706 in the forward direction and points 708 in the backwards direction at once, starting with the forward signal and followed by the reverse signal. The small delay between the two directions is the “re-arm” time of the recording instruments, in which no data is collected. This “Full-Cycle” approach more accurately fits the time in between the same landmark features' location in the forward and backwards directions. In other words, the Full-Cycle fitting would correct time-axis locations between 0 and 1 ms in FIGS. 7A, 7B. The true function should then be expected to be periodic with a period equal to that of the frequency modulation.

Returning to FIG. 14, at 1030, in an embodiment, the transform model is subsequently used to correct for a timing error in subsequent performed ECOPS optical scanning measurements applied to the target sample. That is, at 1030, FIG. 14, a state model is implemented to make real-time corrections to the time-window and a polynomial time-axis calibration to an ASOPS measurement based on Fabry-Perot reflections for accurate time-axis scaling. The resulting polynomial fit can then be used for further measurements within a particular session or until the ECOPS modulation parameters are changed.

FIG. 8 depicts a plot 801 showing the effect of polynomial order on goodness of fit for time-axis correction as measured by the mean-square-error (MSE) of ECOPS peak locations compared to ASOPS peak locations. An 8^{th} order polynomial function is selected for subsequent time-axis modeling. In particular, FIG. 8 shows the MSE of the peak locations in the corrected time-axis results as a function of the fitting polynomial order. These results demonstrate that increasing the order of the fitting polynomial has diminishing returns beyond the 8^{th} order. Therefore, in the subsequent sections, there is used an 8^{th} order polynomial function as in Eq. (10).

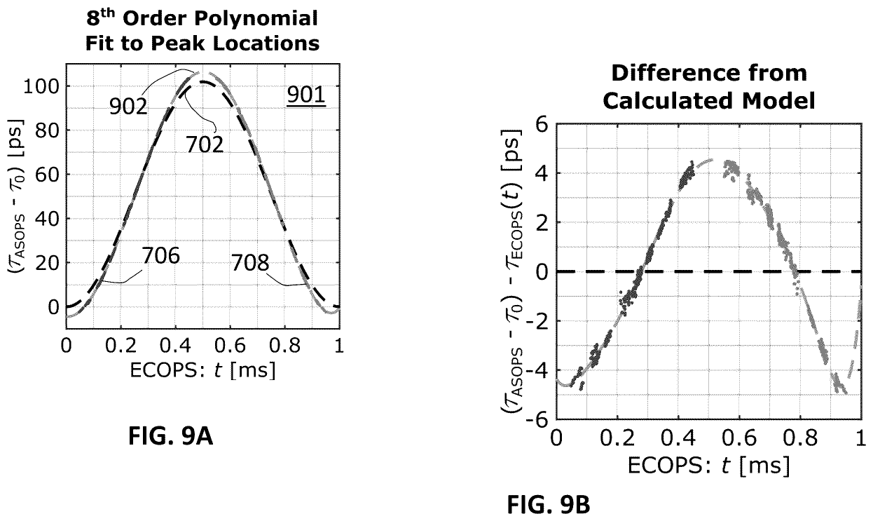

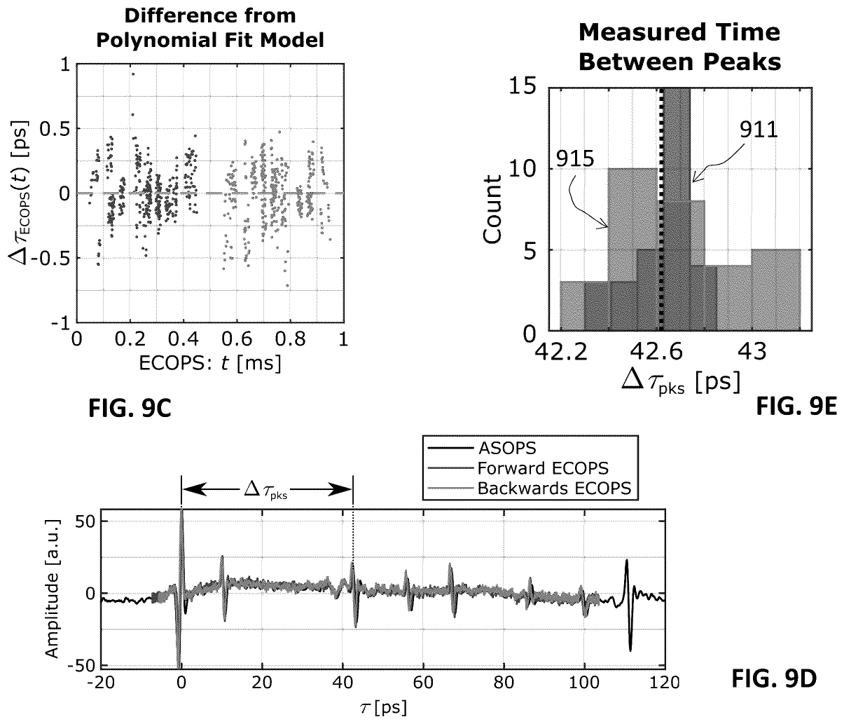

FIGS. 9A-9D show the application of the 8^{th} order polynomial time axis correction to Fabry-Perot reflections in FIGS. 6A-6C. FIG. 9A in particular shows a plot 901 depicting a comparison between the model calculated from Eq. (7) dashed line 702 and polynomial fit 902 to the actual peak locations lines 706, 708. It is shown in FIG. 9A that this polynomial function, line 902, agrees with the experimental measurements much better in comparison to the theoretical model shown by the dashed line 702. In particular, FIG. 9B shows that the time-axis error between the theoretical model and the ECOPS measurements can reach several picoseconds in a full-cycle measurement. As shown in FIG. 9C, however, this error, i.e., Δτ_{ECOPS}(t), the difference between the measured locations and the polynomial model, is approximately uniform and smaller than 1 picosecond. As a result, there is a better match between the ASOPS and ECOPS signals in both directions as shown in FIG. 9D. Specifically, in FIG. 9E, the delay between the pulses labeled by Δτₚₖₛ in FIGS. 6B and 9D is reduced from 2 and 4 picoseconds in the forward and backwards direction, respectively, to less than 0.3 picosecond in the forward direction 911 and less than 0.6 picosecond in the backwards direction 915.

In particular, FIG. 9A depicts a comparison between the model calculated from Eq. (7), e.g., line 702, and polynomial fit 902 to the actual peak locations. The difference from the calculated model FIG. 9B and difference from the polynomial fit FIG. 9C highlights the improved correspondence to ASOPS peak locations. In FIG. 9D, the corrected time domain signal and FIG. 9E measurement of Δτₚₖₛ demonstrates that after nonlinear time-axis correction the ECOPS traces much more closely match each other and the ASOPS reference. The histogram data are obtained from 30 ECOPS measurements of the sample in FIG. 6.

When using different ECOPS frequency modulation parameters, i.e., f_{M} and Δf values, following the polynomial fitting method described resulted in different 8^{th} order polynomial time-axis corrections, however with similar accuracy in modeling the non-linear time-domain sampling (data not shown). Although results shown in FIGS. 9A-9D indicate that the error of time-axis sampling can be markedly reduced, the effect of the residual difference in spectroscopic measurements must be investigated. In the following, the 8^{th} order polynomial time-axis corrections were used to model and correct for the non-linear time-axis behavior in evaluating the performance of the PHASR 2.0 Scanner.

### Investigation of Practical Limits

In order to validate the imaging capabilities of the PHASR Scanner 2.0 and the accuracy of the THz-TDS measurements in the ECOPS mode, measurements are compared against ASOPS data of the same type. In particular, four aspects of the THz-TDS measurements were examined: jitter, dynamic range, usable bandwidth, and spectroscopic accuracy. The first three values were calculated from measurements of a flat mirror while the spectroscopic accuracy was calculated based on the well-studied resonance of lactose at 0.53 THz. In each case, the performance metric was estimated from 100 independent acquisitions obtained as single point spectroscopy measurements on the sample and without the optional imaging window. These measurements were repeated using different setting values, which affect the acquisition rate: i.e., f_{M} for ECOPS, as well as the number of time-domain traces averaged per acquisition and Δf for both ASOPS and ECOPS. Per the manufacturer's users' manual, the Δf values of the ASOPS system can be selected between 1 and 1000 Hz. Since the aim for employing ECOPS measurements is primarily to provide faster acquisition rate than the capabilities of the existing ASOPS system, the examined modulation frequencies were limited to 800 Hz and 1000 Hz. After time-axis correction, a gaussian high-pass filter (μ=0 THz, σ=0.05 THz) was applied to all signals to remove low frequency noise typical of internal reflections within our PHASR Scanner.

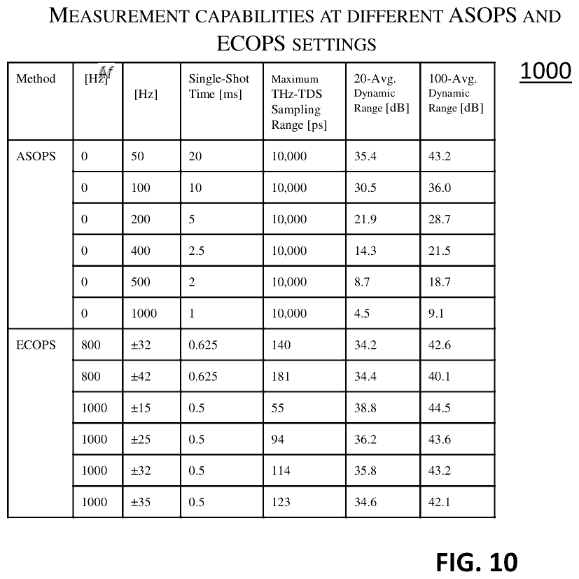

FIG. 10 shows a table 1000 depicting single-shot acquisition time and the maximum THz-TDS sampling range for each of the setting values. Also, the table 1000 shown in FIG. 10 includes the dynamic range values, further explored in a discussion of dynamic range and usable bandwidth, for 20 and 100 averages of the THz-TDS measurements. For ASOPS measurement, improving acquisition speed by increasing the difference frequency setting results in poorer dynamic range but has no effect on the sampling range. On the other hand, changing the ECOPS modulation settings of Δf and f_{M} have comparatively little effect on the dynamic range of the measurements, but imposes limits on the length of TDS signal, which can be acquired.

### Jitter

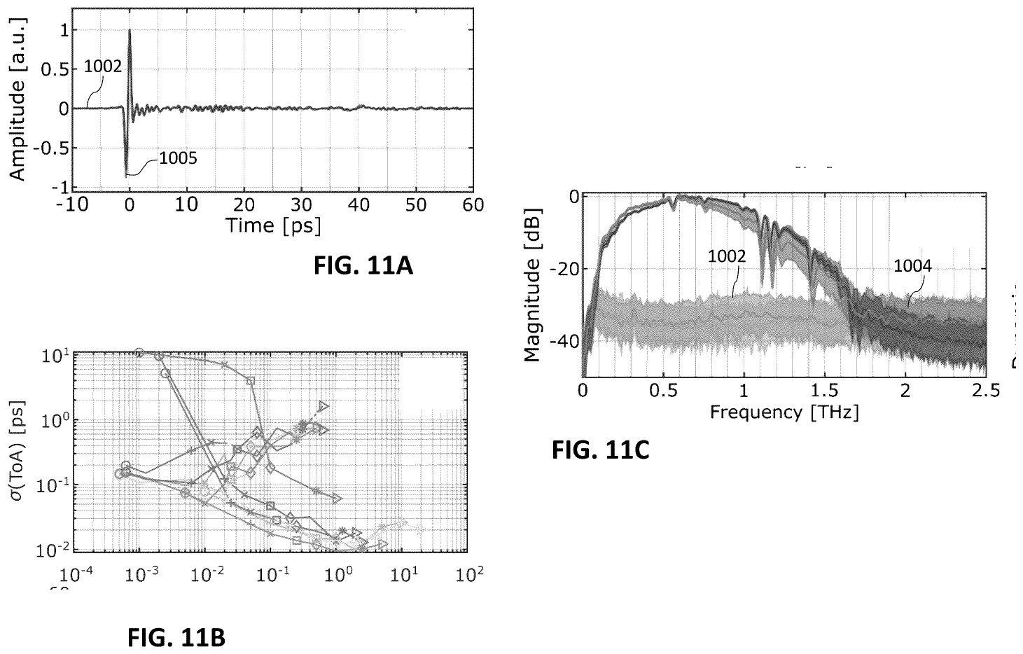

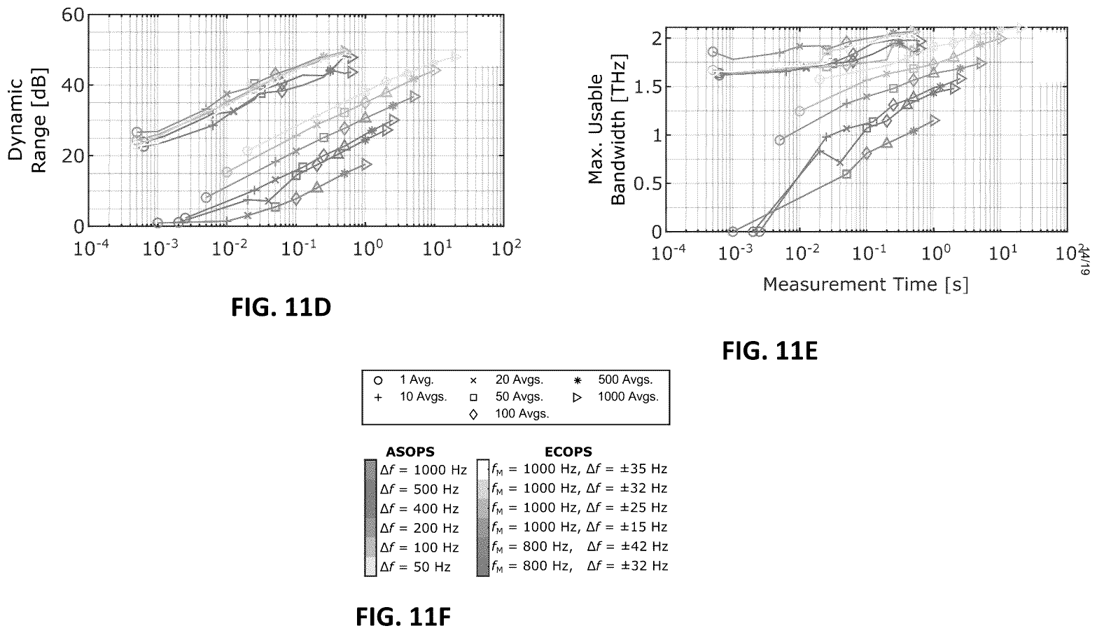

Consistent timing is vital to time-of-flight and phase-based measurements common to THz-TDS techniques such as material parameter extraction and thickness determination. A representative comparison between the ASOPS and ECOPS time-domain measurements obtained at the center of a flat mirror placed at the focal point is shown in FIG. 11A. In particular, FIG. 11A depicts a normalized representative time domain signals 1002 reflected from a flat mirror obtained using ASOPS (Δf=50 Hz, 20 avg.) and representative time domain signals 1005 using ECOPS (f_{M}=1000 Hz, Δf=±25 Hz, 20 avg.) methods. The jitter is defined by the standard deviation of the time of arrival (ToA) of the reflected pulse as measured by the location of the maximum amplitude in the time-domain. FIG. 11B shows the performance of both techniques at different settings. FIG. 11F is a color key for describing the ASOPS and ECOPS values in the various plots of FIG. 11B-11E. In particular, FIG. 11B depicts a standard deviation of time of arrival (ToA) for all sets of ASOPS and ECOPS acquisitions as a function of measurement time. Notably, single-shot ASOPS measurements at Δf≥400 Hz suffered from poor SNR such that a typical THz-TDS pulse could not be identified in the recorded trace. For example, single-shot ASOPS acquisitions of Δf=500 and 1000 Hz were nearly indistinguishable from noise, requiring special effort to manually locate the correct time window for measurement. Increasing the number of traces averaged per ASOPS acquisition typically decreases the noise, improving precision in calculations involving time of flight or phase measurements. However, this trend reverses for acquisitions which take more than about a second. In contrast, our implementation of ECOPS only improves up to around 20 traces/acquisition. In both cases this indicates that arbitrarily large averaging is inadvisable due to the limits on the stability of the difference frequency, though for ECOPS this is also in part due to the limits of the simple drift compensation model.

### Dynamic Range and Usable Bandwidth

In addition to time-resolved measurements, much of the strength of the THz-TDS imaging is due to the ability to measure broadband spectra. Representative frequency domain reference measurements for both ASOPS and ECOPS are shown in FIG. 11C along with comparable measurements without the presence of the reference mirror to establish the noise floor. In particular, FIG. 11C depicts Fourier transform of the time domain signals in FIG. 11A as well as noise measurements in ASOPS 1102, and ECOPS 1104, acquired with the same parameters. Shaded areas show standard deviation over 100 acquisitions. FIG. 11D depicts a maximum dynamic range and FIG. 11E depicts a maximum usable bandwidth of each set of acquisitions as a function of measurement time. The peak dynamic range, calculated as the maximum ratio of the signal to the noise floor in the frequency domain, is shown in FIG. 11D. Usable bandwidth is then calculated as the frequency at which the dynamic range first falls to below 3 dB and is plotted in FIG. 11E. Some ASOPS measurements with high difference frequency and low averaging did not exceed this threshold at any point, resulting in a bandwidth of 0 THz. Since the magnitude of the frequency spectra is not affected by the timing of the pulse, the drift does not affect broadband frequency performance, determined using the magnitude of the Fourier transformation of the TDS pulses, in the same way that it affected the ToA measurements. Thus as expected, increasing the averaging lowers the noise floor, improving both the dynamic range and usable bandwidth of the measurements. The effect of increasing averaging suppresses the noise floor for all settings, resulting in the parallel trends in dynamic range plot. Most notably, ECOPS measurements offer approximately 10-20 dB higher dynamic range as compared to the ASOPS measurements. Furthermore, decreasing the ASOPS difference frequency improves the performance in both measures. ECOPS, which operates with even lower difference frequencies, shows similar capability to that of the best ASOPS setting (Δf=50 Hz) when comparing measurements with similar averaging despite the significantly shorter ECOPS measurement times.

The effect of measurement speed on bandwidth is not as easily defined. Two series of water absorption lines beginning at approximately 1.1 and 1.7 THz, visible in FIG. 11C, naturally limit dynamic range in their vicinity and create artificial striation in the measured bandwidth values. We have used a centered moving average filter, with 0.2 THz width applied to the signal spectra, as a simple method to remove the water absorption lines and other spectral fluctuations. Following this step, FIG. 11E shows that, similar to the dynamic range, the bandwidth of the ASOPS measurements show a marked improvement with decreasing difference frequency. The bandwidth of the ECOPS measurements are higher than all ASOPS settings with similar numbers of averaging. However, the improvement in ECOPS bandwidth with increasing averaging is modest. This behavior is the result of the differing shapes of the spectral density of the noise floor in each technique, as illustrated for instance above 1.7 THz in FIG. 11C. In general, higher difference frequencies result in a steeper negative slope in the noise floor, while lower difference frequency values produce a flat noise floor.

### Spectroscopic Accuracy

To characterize the ability of the modified system to accurately measure frequency spectra, the measured location of the resonance of lactose, theoretically expected at 0.53 THz, was calculated. The sample consisted of an approximately 4 mm thick pellet consisting of equal parts by mass of α-lactose monohydrate and high-density polyethylene (for binding). The two components were mixed as powders with mortar and pestle and then compressed for 3 hours. The sample was placed on a mirror and the reflection from the back surface (that is, the signal which has passed through twice the sample thickness) was captured. The location of the resonance was then determined by finding the location of the minimum spectral amplitude in the area between 0.45 and 0.65 THz. This test provides additional insight into how well the nonlinear time-axis sampling correction performs over large sections of the signal, as incorrect scaling will lead to frequency shifts.

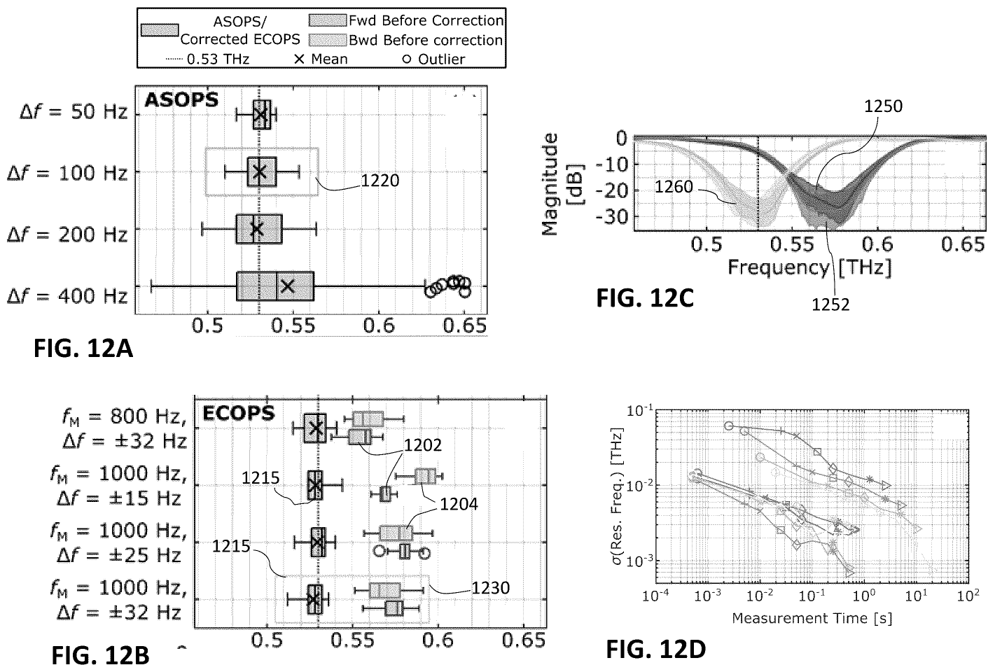

FIGS. 12A-12B show the distribution of the resonance locations using a selection of ASOPS and ECOPS settings after averaging 20 independent traces. For ECOPS measurements, the distribution of the resonances calculated for each direction using Eq. (7) (i.e., without time-axis correction) are also shown in boxes 1202 and 1204. It can be seen that the precision of ASOPS measurements improves as the difference frequency is lowered, however the accuracy of ECOPS measurements remains higher than ASOPS and independent of ECOPS settings after the proposed time-axis correction method. FIG. 12C, for example, compares the spectral location of lactose's resonance for ASOPS measurements marked with the box 1220 in FIG. 12A (Δf=100 Hz) with ECOPS measurements selected by the box 1230 in FIG. 12B (f_{M}=1000 Hz, Δf=+32 Hz) before and after the nonlinear time-axis correction. In particular, FIG. 12C is a frequency domain plot of select ASOPS (Δf=100 Hz, 20 avg., shown as box 1220 in FIG. 12A and ECOPS (f_{M}=1000 Hz, 20 avg, for ECOPS forward direction 1250 and backwards direction 1252 before time-axis correction, respectively, and shown as the plot 1260 after time-axis correction. Area demonstrates mean±standard deviation among 100 acquisitions (50 each of forward and backwards for ECOPS signals). Box 1220 and box 1230 in FIG. 12A and FIG. 12B indicate the corresponding boxplots. The resonance of lactose at 0.53 THz in time-axis corrected ECOPS measurements 1230 overlap exactly with ASOPS results 1220. FIG. 12D depicts a standard deviation of measured resonance location for each set of acquisitions. ECOPS measurements shown only after time-axis correction. Overall, the time-axis corrected ECOPS results 1215 perform better than even the Δf=50 Hz ASOPS measurement, consistent with the trend according to difference frequency described previously. As shown in FIG. 12D, the precision of this measurement improves as increasing averaging reduces the noise. This precision, as measured by standard deviation of the absorption peak location, is plotted for all measurement settings. While the variation decreases with increasing averaging as expected for both techniques, the standard deviation of the ASOPS results is nearly an order of magnitude higher than the corresponding ECOPS measurements which have the same acquisition time.

### Fast Acquisition Demonstration

The THz PHASR 2.0 Scanner uses the methods described herein to achieve record high speeds (highest in the world for THz imaging). The system and method achieves the fastest speed for obtaining THz-TDS scans (more than 2000 wavesforms/scan) over a 100 picosecond sampling range.

The performance metrics of the new ECOPS-based PHASR 2.0 Scanner is now demonstrated by examples. It is shown that the ECOPS mode can be used to take measurements with similar or better frequency-domain performance in significantly less time. These improvements make the PHASR Scanner 2.0 much more practical to use in scenarios such as biomedical imaging where scanning field of view and scanning speed significantly affect the patient experience.

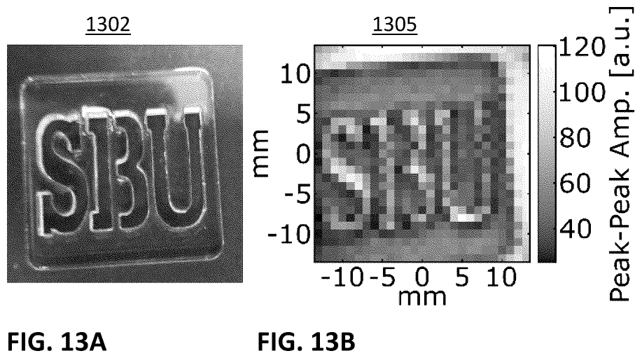

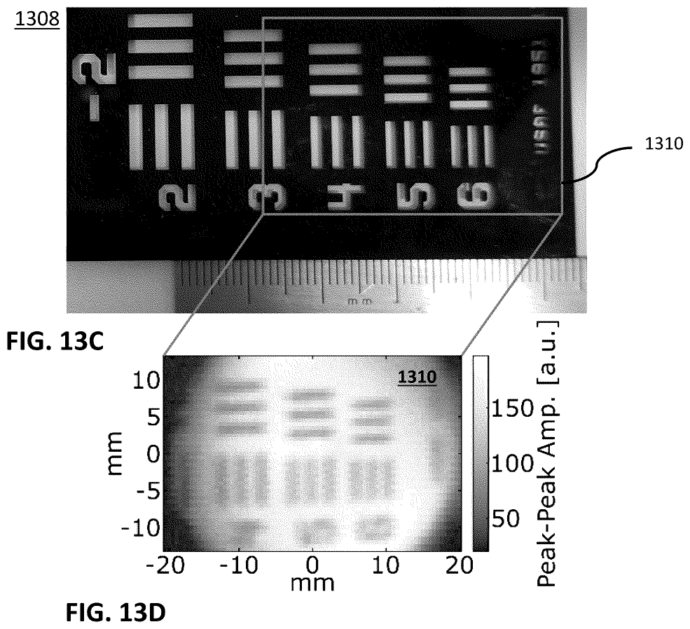

FIGS. 13A-13D depicts demonstration images in an example. FIG. 13A shows a target image (acrylic SBU target) 1302, and FIG. 13B depict a peak-to-peak image 1305 of the acrylic SBU target acquired during the 8-second ECOPS THz-TDS scan. In the example, the overall improvement of the PHASR Scanner 2.0 is demonstrated by its in situ scanning capabilities wherein a scanning time of approximately 8 seconds results over a 27×27 mm² FOV with 1 mm pixel sizes, (i.e., a 729-pixel image). The scan was acquired at f_{M}=1000 Hz, Δf=±32 Hz, for a 2000 THz-TDs trace/s acquisition rate. The acrylic target 1302 and peak-to-peak amplitude image 1305 of the scan is shown in FIGS. 13A and 13B, respectively. Each pixel represented the average of 10 time-domain traces. To ensure that the pixels conform to a grid, each line of the scan consisted of an acceleration period, a constant speed section covering the FOV, and then a deceleration period and movement to the next line. Data was acquired during the constant speed section without pausing the beam-steering for each pixel. The acceleration, deceleration, and line step periods added an additional overhead time of 154 ms/line or 4.0 seconds for an entire image, during which THz traces were not used.

A 1951 USAF Resolution Test Target provides a second demonstration case for the full field of view of the PHASR 2.0 scanner. The area containing elements 4-6 of group −2 (line widths ranging from 1.41 to 1.12 mm) and the resulting THz peak-to-peak image are shown in FIGS. 13C and 13D, respectively. The circular area of the ECOPS image clearly shows the boundaries of the lens area. In particular, in the second demonstration, FIG. 13C is a visual image 1308 of group −2 of a 1951 USAF Resolution test target and FIG. 13D shows a corresponding THz peak-to-peak image 1320 from an ECOPS scan. FIG. 13D particularly shows the full FOV (corresponding to the box 1310 in FIG. 13C) of the scanner. The vertical direction is limited by the range of the goniometer while the horizontal range is limited by the aperture of the lens (circular profile).

Implementing a heliostat gimbal geometry drastically reduced the inherent distortion from the scanning system and improved the scanning range from 12×19 mm² to 40×27 mm². This is combined with small modifications to the commercial ASOPS system, which allowed ECOPS operation of up to 2000 trace/s measurement rate. To implement this change, the existing ASOPS hardware is used, though specific attention is required to reduce signal drift and non-linear time-axis sampling inherent to this upgrade. In particular, a state model is implemented to make real-time corrections to the time-window and a polynomial time-axis calibration to an ASOPS measurement based on Fabry-Perot reflections for accurate time-axis scaling. The resulting polynomial fit can then be used for further measurements within that session or until the ECOPS modulation parameters are changed.

The PHASR 2.0 Scanner THz-TDS imaging device demonstrates ability “in the field” for clinical and industrial applications. For example, results show ability to extend the FOV and speed of the PHASR 1.0 Scanner for imaging large burns with 1″ diameter in several preclinical in vivo studies. Furthermore, recent results have demonstrated the value of polarization-sensitive THz measurement of biological samples, including skin.

The PHASR 2.0 Scanner THz-TDS imaging device is field-deployable and can provide spectroscopic information from the sample. Images obtained from the THz cameras is well suited for techniques such as spectral “fingerprinting”, material parameter extraction (e.g. measuring refractive index), and analysis of scattering behavior. Additionally, THz-TDS can provide structural information and sub-surface imaging based on time-of-flight analysis. Compressive sensing techniques allow for THz-TDS image formation using a stationary system.

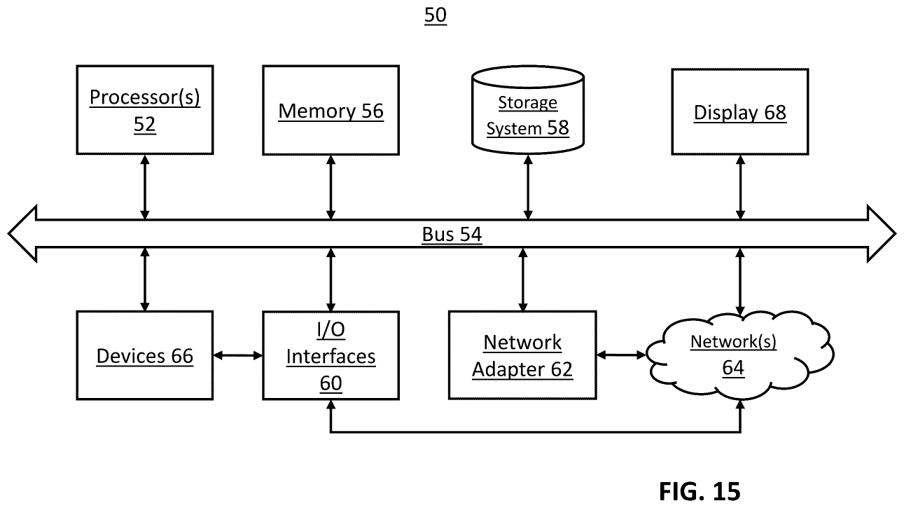

FIG. 15 illustrates a schematic of an example computer or hardware processing system 50 that can implement computing operations for determining the ECOPS polynomial correction function for correcting for the non-linearities present between sample signal sets along the time axis as the ECOPs scanner acquisition speed increases. The computer system 50 is an example of a suitable processing system and is not intended to suggest any limitation as to the scope of use or functionality of embodiments of the methodology described herein. The computer system 50 shown may be operational with numerous other general-purpose or special purpose computing system environments or configurations. Examples of well-known computing systems, environments, and/or configurations that may be suitable for use with the processing system shown in FIG. 1A may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems etc.

The computer system 50 may be described in the general context of computer system executable instructions, such as program modules, being implemented by a computer system. Generally, program modules may include routines, programs, objects, components, logic, data structures, and so on that perform particular tasks or implement particular abstract data types. The computer system 50 may be practiced in distributed cloud computing environments where tasks are performed by remote processing devices that are linked through a communications network. In a distributed cloud computing environment, program modules may be located in both local and remote computer system storage media including memory storage devices.

The components of computer system 50 may include, but are not limited to, one or more processors or processing units 52, a system memory 56, a bus 54, storage system(s) 58, I/O interface(s) 60, network adapter(s) 62, network 64, devices 66, and display(s) 68. Bus 54 may couple various components of computer system 50. The processor 52 may include modules (e.g., programming modules) that performs the methods described herein. The modules among processor 52 may be programmed into the integrated circuits of the processor 52, or loaded from memory 56, storage device 58, or network 64 or combinations thereof. Processor 52 can be, for example, a microprocessor, a microcontroller, a processor core, a multicore processor, central processing unit (CPU) of computing devices such as a classical computer, and/or other types of computer processing element.

Bus 54 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Universal Serial Bus (USB), Video Electronics Standards Association (VESA) local bus, and Peripheral Component Interconnects (PCI) bus.

Computer system 50 may include a variety of computer system readable media. Such media may be any available media that is accessible by computer system, and it may include both volatile and non-volatile media, removable and non-removable media.

System memory 56 can include computer system readable media in the form of volatile memory, such as random access memory (RAM) and/or cache memory or others. Computer system may further include other removable/non-removable, volatile/non-volatile computer system storage media. By way of example, storage system 58 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 54 by one or more data media interfaces.

Computer system 50 may also communicate with one or more external devices 66 such as a keyboard, a pointing device, a display 68, network card, modem, etc. that enable a user to interact with computer system and/or that enable computer system 50 to communicate with one or more other computing devices. Devices 66 can be connected to components among computer system 50 via bus 54 and/or input/output (I/O) interfaces 60.

Computer system 50 can communicate with one or more networks 64 such as a local area network (LAN), a general wide area network (WAN), and/or a public network (e.g., the Internet) via network adapter 62 and/or I/O interfaces 60. Computer system 50 can communicate with networks 64 through wired connections (e.g., wires or cables connected to bus 54) or wireless connections (e.g., through network cards among I/O devices 60 and/or network adapter 62). Network adapter 62 can communicate with the other components of computer system 50 via bus 54. It should be understood that although not shown, other hardware and/or software components could be used in conjunction with computer system 50. Examples include, but are not limited to: field-programmable gate array (FPGA), system on chip (SoC), microcode, device drivers, redundant processing units, external disk drive arrays, RAID systems, tape drives, and data archival storage systems, etc.

In some embodiments, the computer system may be described in the general context of computer system executable instructions, embodied as program modules stored in memory 150, being executed by the computer system. Generally, program modules may include routines, programs, objects, components, logic, data structures, and so on that perform particular tasks and/or implement particular input data and/or data types in accordance with the present invention (see e.g., FIGS. 5, 14).

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The corresponding structures, materials, acts, and equivalents of all elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The described aspects and examples of the present disclosure are intended to be illustrative rather than restrictive, and are not intended to represent every aspect or example of the present disclosure. While the fundamental novel features of the disclosure as applied to various specific aspects thereof have been shown, described and pointed out, it will also be understood that various omissions, substitutions and changes in the form and details of the devices illustrated and in their operation, may be made by those skilled in the art without departing from the spirit of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or aspects of the disclosure may be incorporated in any other disclosed or described or suggested form or aspects as a general matter of design choice. Further, various modifications and variations can be made without departing from the spirit or scope of the disclosure as set forth in the following claims both literally and in equivalents recognized in law.

What is claimed is:

1. A method of operating a terahertz (THz) spectrometer comprising:
emitting light by a first laser pulse generator;
configuring, by a motor controller, a 2-Dimensional (2D) gimbaled mirror, the 2D gimbaled mirror comprising a single mirror mounted in a frame and configurable for rotation about a first axis of rotation and a second axis of rotation under a control of the motor controller, said 2D gimbaled mirror adapted to focus the emitted light on a target through a lens;
scanning, using the motor controller, the emitted light on the target in two dimensions;
detecting, by a detector, light signals reflected from the target over a sampling time period,
using a second laser pulse generator to sample the detected light signals at different time-domain sampling locations within the sampling time period, said sampling of the detected light signals within the time period comprising obtaining multiple trace waveforms comprising sampling locations in both forward signal components and backwards signal components over the time period; and
applying a transformation model to adjust the sampling locations of the obtained multiple trace waveforms of the detected light signals over the sampling time period to correct for a non-linearity present between expected locations of features within the detected light signals reflected from the sample and corresponding locations of the features in both said sampled both forward signal components and backwards signal components.

2. The method of claim 1, wherein the sampling of the detected light signals over a time period using the second laser pulse generator to obtain said multiple trace waveforms having both forward signal components and backwards signal components is based on results of an electronically controlled optical scanning (ECOPs) THz measurement applied to the sample.

3. The method of claim 2, further comprising:
generating the transformation model used to adjust the sampling locations of the obtained multiple trace waveforms of the detected light signals over the time period, said transformation model generating comprising:
initially determining expected locations of features of the reflected light pulses acquired from a reference sample over the time period;
comparing the expected locations of features of the reflected light pulses from the reference sample with corresponding features in both said forward signal components and backwards signal components of the sampled detected light signals over the time period using the ECOPS THz measurement; and
generating, using a hardware processor, a model describing a transformation of said each said corresponding feature location of said forward signal components and backwards signal components of the detected light signals for the reference sample and the corresponding expected locations of said reflected light pulses.

4. The method of claim 3, wherein the reference sample comprises a reference stack of material layers, one layer comprising a transparent semiconductor material and an underlying layer comprising a reflective material for reflecting light pulses for sampling by the probe laser.

5. The method of claim 3, wherein said initially determining expected locations of reflected light pulses from the reference sample comprises: obtaining a ground truth signal over the time period prior to obtaining the sampled detected light signals using the ECOPS THz measurement.

6. The method of claim 5, wherein said ground truth signal is obtained based on parameters of the reference sample over the time period.

7. The method of claim 5, wherein said ground truth signal comprises a detected light signal obtained based on results of an asynchronous optical scanning (ASOPs) THz measurement applied to the reference sample.

8. The method of claim 5, wherein detected light signals over the time period in both forward signal components and backwards signal components based on said ECOPs measurements have features at time-domain locations associated with corresponding features at time-domain locations expected in the ground truth signal, said generating a transformation model further comprising:
fitting, by the hardware processor, a polynomial function in data points representing time domain differences between the time-domain locations of the features in both forward signal components and backwards signal components based on said ECOPs measurements and the corresponding features at expected locations in the ground truth signal.

9. The method of claim 8, further comprising:
determining coefficients of said polynomial function by solving a system of equations, said system of equation relating said time-domain locations of the features in both forward signal components and backwards signal components based on said ECOPs measurements with their determined corresponding features at expected locations in the ground truth signal over the and an initial time sample.

10. A method of calibrating a terahertz (THz) spectrometer comprising:
obtaining, using a processor in the spectrometer, a first set of one or more time domain signals representative of a target sample being scanned over a time period;
obtaining, using the processor in the spectrometer, a second set of time domain signals representative of a target sample being scanned using an electronically controlled optical scanning (ECOPs) THz measurement applied to the target sample, said second set of time domain signals comprising both forward signal components and backwards signal components over the time period;
determining, using the processor, locations of one or more features in the first set of signals within the time period;
determining corresponding one or more features in the second set of signals within the time period, said corresponding one or more features of the second set of time domain signals having different locations within said time period;
generating, using the processor, a model used to temporally transform the second set of signals into a set of signals so that the corresponding one or more features within the time period align with the locations of one or more features in the first set of signals within the time period; and
using the model to correct for a timing error in subsequent performed ECOPS optical scanning measurements applied to the target sample.

11. The method of claim 10, wherein said first set of signals including said determined one or more features within the time period comprises a ground truth signal.

12. The method of claim 11, wherein said determining corresponding one or more features in the second set of signals within the time period comprises: comparing each forward signal components and backwards signal components of the second set of signals over the time period against determined feature locations from the ground truth signal.

13. The method of claim 11, wherein said one or more features comprise first time-domain reflection peaks in the first set of signals and the corresponding one or more features comprise time-domain reflection peaks in the second set of signals that are unaligned in time with said first time-domain reflection peaks in the first set of signals.

14. The method of claim 12, wherein the obtaining a first set of time domain signals representative of the target sample being scanned over a time period comprises: using the handheld scanner to obtain asynchronous optical scanning (ASOPs) THz measurements applied to the sample in one or more sampling acquisitions.

15. The method of claim 14, wherein to generate the transform model, said hardware processor is further configured to: generate a polynomial function describing a transformation between the locations of the corresponding one or more features of the second set of signals and the feature locations in the ground truth signal to provide a time-axis calibration of subsequent ECOPs measurements to correct a non-linearity present between the first set of time domain signals and the second set of time domain signals.

16. The method of claim 15, wherein said generated polynomial function is of order N according to:
$$τ ( t ) - {τ}_{0} = {\sum }_{P = 1}^{N} {C}_{P} {t}^{P}$$
where to generate said polynomial function, said method further comprises:
identifying, by the hardware processor, features labeled a, b, c, . . . at corresponding time locations τₐ, τ_{b}, τ_{c}, . . . from the ground truth signal;
associating the identified features to corresponding time locations tₐ, t_{b}, t_{c}, . . . within the forward signal components and backwards signal components of the second set of signals over the time period; and
determining a set of polynomial coefficient C_{P} values where p==1, 2, . . . , N−1, N and an initial sampling point τ₀ value of the time period using a least-squares fitting algorithm produced by numerically solving a matrix equation according to:
$$[ \begin{matrix}{( {t}_{a} )}^{N} & {( {t}_{a} )}^{N - 1} & … & {t}_{a} & 1 \\ {( {t}_{b} )}^{N} & {( {t}_{b} )}^{N - 1} & … & {t}_{b} & 1 \\ {( {t}_{c} )}^{N} & {( {t}_{c} )}^{N - 1} & … & {t}_{c} & 1 \\ ⋮ & ⋮ & ⋮ & ⋮ & ⋮\end{matrix} ] = [ \begin{matrix}{C}_{N} \\ {C}_{N - 1} \\ ⋮ \\ {C}_{1} \\ {τ}_{0}\end{matrix} ] = [ \begin{matrix}{τ}_{a} \\ {τ}_{b} \\ {τ}_{c} \\ ⋮\end{matrix} ]$$
wherein the polynomial coefficient values, C_{P}, model the shape of the ECOPS time sampling measurements.

17. The method of claim 15, further comprising:
applying multiple ASOPs sampling acquisitions to the target sample, each sampling acquisition having a different initial sampling point to value and obtaining different time window locations; and
obtaining, by the hardware processor, multiple pairs M of second signal sets, each pair of said M pairs of second signal sets comprising the forward signal components and backwards signal components over the time period from said ECOPs optical scanning measurements, each of the multiple pairs of second signal sets starting at a different time location and producing a location of reflections at different times t.

18. The method of claim 17, wherein said generated polynomial function is of order N according to:
$$τ ( t ) - {τ}_{0} = {\sum }_{P = 1}^{N} {C}_{P} {t}^{P}$$
where to generate said polynomial function, said method further comprises:
identifying, by the hardware processor, features labeled a, b, c, . . . at corresponding time locations Tᵢₘ where i=a, b, c, . . . and m=1, 2, . . . , M, from the ground truth signal;
associating the identified features to corresponding locations tᵢₘ where i=a, b, c, . . . and m=1, 2, . . . , M, within the forward signal components and backwards signal components of each pair of the multiple pairs of M second signal sets over the time period; and
determining a set of polynomial coefficient C_{P} values, where p==1, 2, . . . , N−1, N, and initial sampling points Tom value, where m=1, 2, . . . , M, of the time period using a least-squares fitting algorithm produced by numerically solving a matrix equation according to:
$$[ \begin{matrix}{( {t}_{a , 1} )}^{N} & {( {t}_{a , 1} )}^{N - 1} & … & {t}_{a , 1} & 1 & 0 & 0 & … & 0 \\ {( {t}_{b , 1} )}^{N} & {( {t}_{b , 1} )}^{N - 1} & … & {t}_{b , 1} & 1 & 0 & 0 & … & 0 \\ {( {t}_{c , 1} )}^{N} & {( {t}_{c , 1} )}^{N - 1} & … & {t}_{c , 1} & 1 & 0 & 0 & … & 0 \\ ⋮ & ⋮ & ⋱ & ⋮ & ⋮ & ⋮ & ⋮ & ⋱ & ⋮ \\ {( {t}_{a , 2} )}^{N} & {( {t}_{a , 2} )}^{N - 1} & … & {t}_{a , 2} & 0 & 1 & 0 & … & 0 \\ {( {t}_{b , 2} )}^{N} & {( {t}_{b , 2} )}^{N - 1} & … & {t}_{b , 2} & 0 & 1 & 0 & … & 0 \\ {( {t}_{b , 2} )}^{N} & {( {t}_{c , 2} )}^{N - 1} & … & {t}_{c , 2} & 0 & 1 & 0 & … & 0 \\ ⋮ & ⋮ & ⋱ & ⋮ & ⋮ & ⋮ & ⋮ & ⋱ & ⋮ \\ {( {t}_{a , M} )}^{N} & {( {t}_{a , M} )}^{N - 1} & … & {t}_{a , M} & 0 & 0 & 0 & … & 1 \\ {( {t}_{b , M} )}^{N} & {( {t}_{b , M} )}^{N - 1} & … & {t}_{b , M} & 0 & 0 & 0 & … & 1 \\ {( {t}_{c , M} )}^{N} & {( {t}_{c , M} )}^{N - 1} & … & {t}_{c , M} & 0 & 0 & 0 & … & 1 \\ ⋮ & ⋮ & ⋮ & ⋮ & ⋮ & ⋮ & ⋮ & ⋮ & ⋮\end{matrix} ] \times [ \begin{matrix}{C}_{N} \\ {C}_{N - 1} \\ ⋮ \\ {C}_{1} \\ {τ}_{01} \\ {τ}_{02} \\ {τ}_{03} \\ ⋮ \\ {τ}_{0 M}\end{matrix} ] = [ \begin{matrix}{t}_{a , 1} \\ {t}_{b , 1} \\ {t}_{c , 1} \\ ⋮ \\ {t}_{a , 2} \\ {t}_{b , 2} \\ {t}_{c , 2} \\ ⋮ \\ {t}_{a , M} \\ {t}_{b , M} \\ {t}_{c , M} \\ ⋮\end{matrix} ]$$
wherein the polynomial coefficient values, C_{P}, model the shape of the multiple pairs of ECOPS sampling measurements.

19. A terahertz (THz) spectrometer comprising:
a first laser pulse generator for emitting light;
a motor controller for controlling a 2-Dimensional (2D) gimbaled mirror, the 2D gimbaled mirror comprising a single mirror mounted in a frame and configurable for rotation about a first axis of rotation and a second axis of rotation under a control of the motor controller, said 2D gimbaled mirror adapted to focus the emitted light on a target through a lens;
a signal detector for detecting light signals reflected from the target over a sampling time period;
a second laser pulse generator to sample the detected light signals at different time-domain sampling locations within the sampling time period, said sampling of the detected light signals within the time period comprising obtaining multiple trace waveforms comprising sampling locations in both forward signal components and backwards signal components over the time period; and
a hardware processor coupled to a memory having instructions, said instructions when run by the processor, configure the hardware processor to apply a transformation model for adjusting the sampling locations of the obtained multiple trace waveforms of the detected light signals over the sampling time period to correct for a non-linearity present between expected locations of features within the detected light signals reflected from the sample and corresponding locations of the features in both said sampled both forward signal components and backwards signal components.

20. The spectrometer of claim 19, wherein the sampling of the detected light signals over a time period using the second laser pulse generator to obtain said multiple trace waveforms having both forward signal components and backwards signal components is based on results of an electronically controlled optical scanning (ECOPs) THz measurement applied to the sample.

21. The spectrometer of claim 20, wherein said hardware processor is further configured to:
generate the transformation model used to adjust the sampling locations of the obtained multiple trace waveforms of the detected light signals over the time period, wherein to generate the transformation model, said hardware processor is further configured to:
initially determine expected locations of features of the reflected light pulses acquired from a reference sample over the time period;
compare the expected locations of features of the reflected light pulses from the reference sample with corresponding features in both said forward signal components and backwards signal components of the sampled detected light signals over the time period using the ECOPS THz measurement; and
generate a model describing a transformation of said each said corresponding feature location of said forward signal components and backwards signal components of the detected light signals for the reference sample and the corresponding expected locations of said reflected light pulses.

22. The spectrometer of claim 21, wherein the reference sample comprises a reference stack of material layers, one layer comprising a transparent semiconductor material and an underlying layer comprising a reflective material for reflecting light pulses for sampling by the probe laser.

23. The spectrometer of claim 21, wherein to initially determine expected locations of reflected light pulses from the reference sample, said hardware processor is further configured to:
obtain a ground truth signal over the time period prior to obtaining the sampled detected light signals using the ECOPS THz measurement.

24. The spectrometer of claim 23, wherein said ground truth signal is obtained based on parameters of the reference sample over the time period.

25. The spectrometer of claim 23, wherein said ground truth signal comprises a detected light signal obtained based on results of an asynchronous optical scanning (ASOPs) THz measurement applied to the reference sample.

26. The spectrometer of claim 23, wherein detected light signals over the time period in both forward signal components and backwards signal components based on said ECOPs measurements have features at time-domain locations associated with corresponding features at time-domain locations expected in the ground truth signal, wherein to generate the transformation model, said hardware processor is further configured to:
fit a polynomial function in data points representing time domain differences between the time-domain locations of the features in both forward signal components and backwards signal components based on said ECOPs measurements and the corresponding features at expected locations in the ground truth signal.

27. The spectrometer of claim 26, wherein said hardware processor is further configured to:
determine coefficients of said polynomial function by solving a system of equations, said system of equation relating said time-domain locations of the features in both forward signal components and backwards signal components based on said ECOPs measurements with their determined corresponding features at expected locations in the ground truth signal over the and an initial time sample.
